(19) United States
(12) Patent Application Publication
(10) Pub. No.: US 2005/0271985 A1
(43) Pub. Date: Dec. 8, 2005

(54) Method, apparatus and system for rinsing substrate with pH-adjusted rinse solution

(75) Inventors: Katsuhiko Miya, Kyoto (JP); Akira Izumi, Kyoto (JP); Takuya Kishimoto, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/140,451

(22) Filed: May 27, 2005

(30) Foreign Application Priority Data
Jun. 7, 2004 (JP) 2004-168304
Sep. 6, 2004 (JP) 2004-258607
Apr. 11, 2005 (JP) 2005-113119

(51) Int. Cl. C11D 3/00

(52) U.S. Cl. 430/323

(57) ABSTRACT

Nitrogen is dissolved in pure water and hydrochloric acid is mixed in this nitrogen-dissolved pure water, thereby creating as a rinsing liquid a mixture liquid whose pH is lower than that of pure water, and thus created rinsing liquid is supplied at nozzles 6 and 25 toward a substrate W. In the case of such a rinsing liquid, the dissolved oxygen concentration in the rinsing liquid is lowered, and it is possible to suppress a rapid increase of the dissolved oxygen concentration in the rinsing liquid as it is immediately after injected at the nozzles 6 and 25. Also suppressed is elution of Si from the surfaces of the substrate.

### CROSS REFERENCE TO RELATED APPLICATION

The disclosure of Japanese Patent Applications enumerated below including specification, drawings and claims is incorporated herein by reference in its entirety:
No. 2004-168304 filed Jun. 7, 2004;
No. 2004-258607 filed Sep. 6, 2004; and
No. 2005-113119 filed Apr. 11, 2004.

### BACKGROUND OF THE INVENTION

1. Field of the Invention

The present invention relates to a substrate processing method, a substrate processing apparatus and a substrate processing system in which a rinse solution is supplied to a substrate, thereby rising the substrate. The substrate includes semiconductor wafers, glass substrates for photomask, glass substrates for liquid crystal display, glass substrates for plasma display, optical disk substrates and the like.

2. Description of the Related Art

A method of manufacturing electronic components for semiconductor devices, liquid crystal display devices and the like include a step at which processing such as film deposition and etching is repeated on the surfaces of a substrate and fine patterns are accordingly formed. For excellent micro-processing, the surfaces of the substrate must be kept clean and the substrate is therefore cleaned if necessary. According to the invention described in Japanese Patent Application Laid-Open Gazette No. H5-29292 for instance, after the surfaces of the substrate are cleaned with a processing liquid which is suitable to cleaning, namely, a cleaning liquid, the processing liquid remaining on the surfaces of the substrate is rinsed off with pure water which is used as a rinse solution. Further, after the end of rinsing, the substrate is rotated at a high speed, thereby draining off the rinse solution remaining on the surfaces of the substrate and the substrate is dried.

Meanwhile, according to the invention described in Japanese Patent Application Laid-Open Gazette No. 2003-92280, after rinsing with CO₂ gas dissolved water as a rinse solution, a substrate is rotated at a predetermined rotation speed. As a result of rotation, the surfaces of the substrate are drained off of the rinse solution remaining thereto and dried. In this invention, the rotation speed of the substrate is changed over multiple levels, to thereby prevent drops (i.e., the rinse solution containing the chemical solution atmosphere) on the surfaces of the substrate from moving at a high speed and accordingly suppress creation of striping with particles (one kind of watermarks attributable to deposition of the chemical solution).

### SUMMARY OF THE INVENTION

However, when pure water is used as the rinse solution, a problem arises that dissolved oxygen contained in the pure water oxidizes all or some of the surfaces of a substrate which have been favorably cleaned with the cleaning liquid and oxide films are formed on the surfaces of the substrate. An approach heretofore implemented to solve this problem is reducing the dissolved oxygen concentration in the rinse solution.

Despite this, during rinsing in reality, the rinse solution is injected at a rinsing nozzle toward the surfaces of the substrate, and the rinse solution is exposed to air as soon as it is injected at the nozzle. Hence, even when the dissolved oxygen concentration in the rinse solution has been reduced in advance, oxygen in air gets dissolved in the rinse solution immediately after injection of the rinse solution at the nozzle. Therefore, the dissolved oxygen concentration in the rinse solution rapidly increases. In addition, dissolution of oxygen in air into the rinse solution not only occurs right after injection at the nozzle but continuous and progresses at a predetermined pace. It is therefore important to reduce the amount of oxygen which gets dissolved in the rinse solution after injection at the nozzle. In other words, reduction of the dissolved oxygen concentration in the rinse solution while the surfaces of a substrate are wet with the rinse solution, that is, from the start of rinsing until the end of drying (which is approximately thirty seconds for instance) is very important to prevent rinsing-induced oxidation of the surfaces of the substrate. No effective actions have been taken however on this problem, and there still is great room for improvement.

There may arise another problem of watermarks, one type of defects, which are stains appearing in a substrate surface which has been dried. Like oxidation of the surfaces of a substrate, watermarks in the surfaces of a substrate lead to various types of troubles such as an increased contact resistance and pattern defects. Although a watermark is known to be attributable also to elution of an oxidized substance (Si in the case of an Si substrate) to a rinse solution from the surfaces of a substrate during drying, elution of Si to a rinse solution is not suppressed sufficiently where pure water, CO₂ gas dissolved water or the like is used as the rinse solution as in the case of a conventional apparatus. Rinsing which takes place immediately before drying may therefore give rise to elution of Si to a rinse solution and hence create watermarks in the surfaces of the dried substrate, and may result in a serious detect such as defective film deposition. During substrate processing of removing an Si oxide film on an Si substrate, a poly-Si substrate or the like with an HF-base chemical cleaning liquid in particular, since Si gets exposed and the surfaces of the substrate become hydrophobic, elution of Si can easily create a watermark. No effective actions have been so far taken however on this problem, leaving great room for improvement.

A first object of the present invention is to provide a substrate processing method and a substrate processing apparatus with which it is possible to prevent rinsing from creating a watermark.

A second object of the present invention is to provide a substrate processing method, a substrate processing apparatus and a substrate processing system with which it is possible to prevent rinsing from creating a watermark and prevent creation of an oxide film in a substrate.

In fulfillment of the foregoing objects, a method, an apparatus and a system are provided and are particularly well suited to a technique for rinsing a substrate with a rinse solution including a pure water. In a first aspect of the present invention, to achieve the first object above, diluted hydrochloric acid or diluted hydrofluoric acid is mixed with the pure water so that the pH of the rinse solution is of 5 or lower is created. The pH-adjusted rinse solution (pure water+diluted hydrochloric acid, or pure water+diluted hydrofluoric acid) is supplied to the substrate, whereby the substrate is rinsed with the rinse solution.

In a second aspect of the present invention, to achieve the second object above, a low-pH substance whose pH is lower than that of pure water is mixed with the pure water which is fed in a supply channel, nitrogen is dissolved in a fluid which flows in the supply channel and the fluid is created as the rinse solution. The nitrogen-dissolved pH-adjusted rinse solution is supplied to the substrate, whereby the substrate is rinsed with the rinse solution.

In a third aspect of the present invention, to achieve the second object above, a low-pH substance whose pH is lower than that of the pure water is mixed with the pure water which is fed in a supply channel, a fluid which flows in the supply channel is deaerated and the fluid is created as the rinse solution. The rinse solution is supplied to the substrate, whereby the substrate is rinsed with the rinse solution.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a graph which shows a relationship between the pH of a rinse solution and the area size of watermarks;

FIG. 2 is a cross sectional view of the structure of a substrate processing system as a whole according to a first embodiment of the present invention;

FIG. 3 is a block diagram which shows the configuration of control of the substrate processing system shown in FIG. 2;

FIG. 4 is a flow chart which shows an operation of the substrate processing system shown in FIG. 2;

FIG. 5 is a drawing which shows the structure of a substrate processing system according to a second embodiment of the present invention;

FIG. 6 is a drawing which shows the structure of a substrate processing system according to a third embodiment of the present invention;

FIG. 7 is a graph which shows a relationship between whether nitrogen has been dissolved and the area size of watermarks;

FIG. 8 is a graph which shows a relationship between the pH of a rinse solution, the amount of dissolved oxygen and the amount of elution of Si;

FIG. 9 is a drawing which shows the structure of a substrate processing system according to a fourth embodiment of the present invention;

FIG. 10 is a drawing which shows the structure of a substrate processing system according to a fifth embodiment of the present invention;

FIG. 11 is a drawing which shows the structure of a substrate processing system according to a sixth embodiment of the present invention;

FIG. 12 is a drawing which shows the structure of a substrate processing system according to a seventh embodiment of the present invention;

FIG. 13 is a drawing which shows modification of the substrate processing system according to the fourth embodiment of the present invention;

FIG. 14 is a drawing which shows the structure of a substrate processing system according to other embodiment of the present invention;

FIG. 15 is a drawing which shows the structure of a substrate processing system according to another embodiment of the present invention; and

FIG. 16 is a drawing which shows the structure of a substrate processing system according to still other embodiment of the present invention.

### DETAILED DESCRIPTION OF THE PREFERRED EMBODIMENTS

<Relationship Between pH of Rinse Solution and Area Size of Watermarks>

The inventor of the present invention examined the influence of the pH of a rinse solution over creation of a watermark in a surface of a substrate. To be more specific, the inventor selected Si (silicon) substrates as a typical example of substrates and evaluated watermarks in the surfaces of substrates which were dried after rinsed with pH-adjusted rinse solutions. The pH of the rising liquids were adjusted using diluted hydrochloric acid, one of two substances which effectively reduce the pH of rinse solutions without damaging substrates, namely diluted hydrochloric acid and diluted hydrofluoric acid.

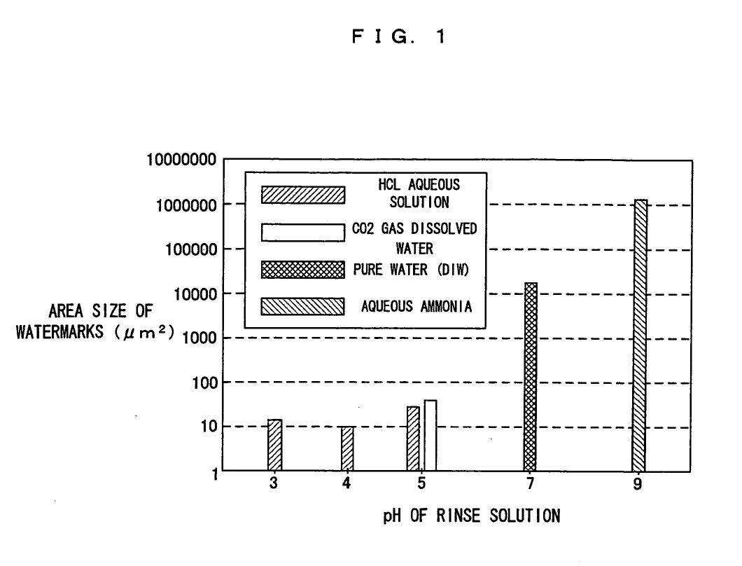

FIG. 1 is a graph which shows a relationship between the pH of a rinse solution and the area size of watermarks. To be more specific, after etching with hydrofluoric acid, the inventor evaluated watermarks which were created on substrates when the substrates were rinsed with rinse solutions which had different pH levels from each other (rinse solutions having pH of 3, 4, 5, 7 and 9 in this example). As target substrates to be evaluated, the inventor used n-type polycrystalline Si substrates which seated patterns and had the diameter of 200 mm (the amount of doping with phosphorus: 4×10²⁰ cm³). As for rinse solutions, the inventor used pure water (deionized water; DIW) as a neutral rinse solution (pH 7), and as an alkaline rinse solution (pH 9), used aqueous ammonia. As acid rinse solution (pH of 3, 4 and 5), the inventor used rinse solutions which were obtained by mixing certain amounts of diluted hydrochloric acid with pure water so that desired pH levels would be attained. As for pH of 5, the inventor conducted evaluation using a rinse solution which was obtained by mixing diluted hydrochloric acid and also for comparison a rinse solution whose pH was adjusted by dissolving carbon dioxide gas (CO₂), instead of diluted hydrochloric acid, with pure water.

The test results shown in FIG. 1 were obtained in the following manner. First, substrates prepared for each rinse solution were treated with hydrofluoric acid (HF process). The substrates were then rinsed respectively with the rinse solutions which had different pH levels from each other and dried. These substrate processing steps used a single-wafer type cleaning apparatus manufactured by Dainippon Screen Mfg. Co., Ltd. (Spin Processor MP-2000). Using KLA-2132, a defect inspection machine manufactured by KLA-Tencor Corporation, the area sizes of watermarks created in the surfaces of thus dried substrates were measured.

As clearly shown in FIG. 1, the rinse solutions having pH of 5 or lower created dramatically less watermarks as compared with the rinse solutions having pH of 7 and 9. Between the pH5-HCl aqueous solution and the CO₂ gas dissolved water having pH of 5, the one whose pH was adjusted by mixing diluted hydrochloric acid with pure water resulted in a smaller area size of watermarks. It is noted that the pH5-HCl aqueous solution was adjusted by mixing diluted hydrochloric acid with pure water. This is because even though a rinse solution (CO₂ gas dissolved water) may be created by dissolving carbon dioxide gas (CO₂) in pure water, it is difficult to perform rinsing while maintaining the dissolved amount of the carbon dioxide gas which has been dissolved in the pure water and the carbon dioxide gas escapes from the rinse solution during rinsing. Single-wafer processing of processing one substrate at a time in particular causes a considerable loss of dissolved carbon dioxide gas before the rinse solution supplied onto a substrate spreads all over a surface of the substrate, and the pH of the rinse solution increases.

Further, more dissolution of carbon dioxide gas in an attempt to lower the pH of a rinse solution (down to a theoretically possible level of about pH 4) merely results in massive consumption of carbon dioxide gas and a hike of running costs. On the contrary, use of diluted hydrochloric acid is free from these problems and addition of a very small amount of diluted hydrochloric acid easily attains adjustment of the pH of a rinse solution.

Noting this, a rinse solution whose pH is adjusted to 5 or lower by mixing diluted hydrochloric acid or diluted hydrofluoric acid with pure water may be used, which prevents creation of a watermark. This will now be described in relation to specific embodiments and with reference to the associated drawings.

### First Embodiment

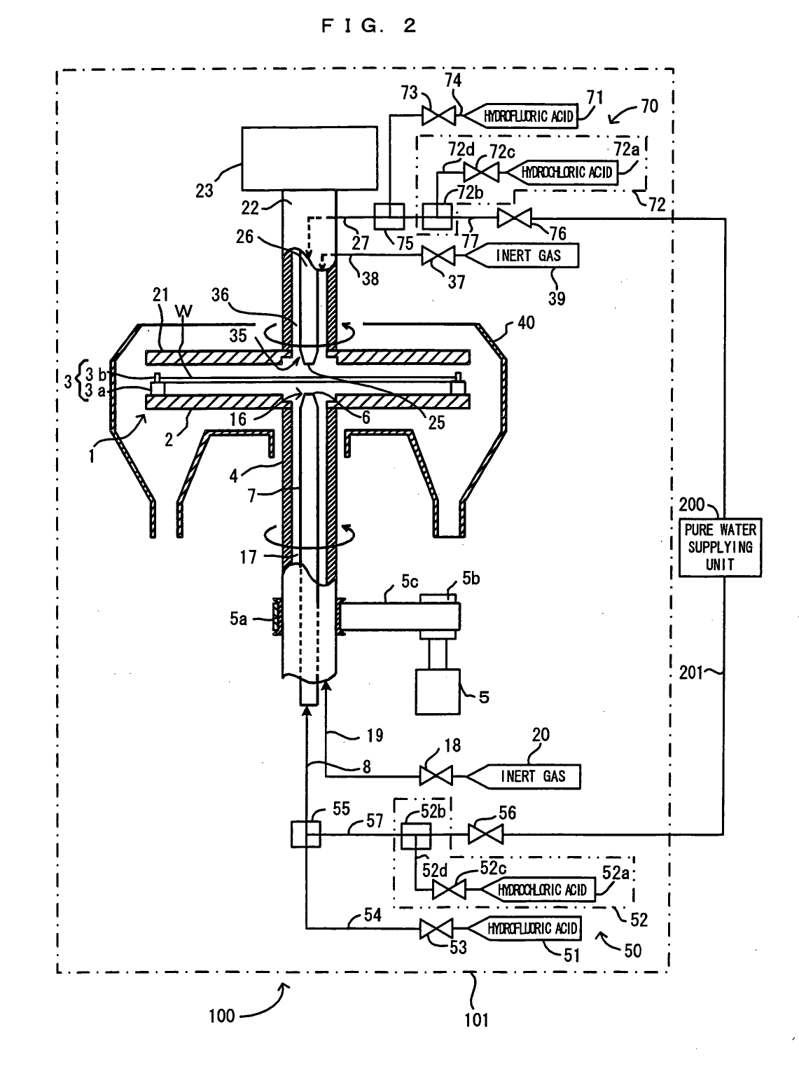

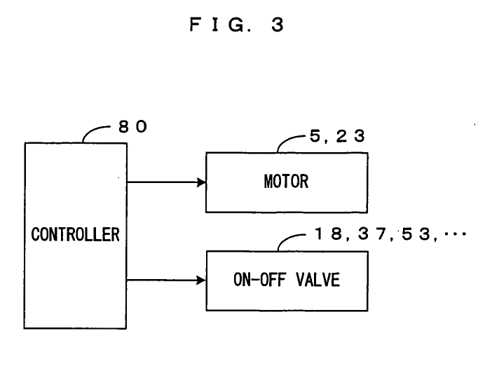

FIG. 2 is a cross sectional view of the structure of the substrate processing system as a whole according to the first embodiment of the present invention. FIG. 3 is a block diagram which shows the configuration of control of the substrate processing system shown in FIG. 2. This substrate processing system comprises a substrate processing apparatus 100 (which also corresponds to the “substrate processing unit” of the present invention) and a pure water supplying unit 200. The pure water supplying unit 200 is disposed separately from the substrate processing apparatus 100 and supplies pure water to the apparatus 100. As shown in FIG. 2, in the same processing main unit 101, the substrate processing apparatus 100 performs film removal, rinsing and drying of a substrate W which is held by a spin chuck 1. Pure water for use in the substrate processing apparatus 100 is supplied to the substrate processing apparatus 100 from the pure water supplying unit 200 via a pipe 201.

The spin chuck 1 comprises a disk-shaped base member 2 which functions also as a blocking member on the back side of the substrate and three or more holding members 3 which are disposed on the top surface of the base member 2. Each holding member 3 comprises a support 3a which supports the substrate W at the outer rim of the substrate W from below and a regulator 3b which restricts the location of the outer rim of the substrate W. The holding members 3 are located near the outer rim of the base member 2. Each regulator 3b is structured such that it can be in an active state where it contacts the outer rim of the substrate W and holds the substrate W and an inactive state where it stays away from the outer rim of the substrate W and releases the substrate W. When the regulators 3b are in the inactive state, a transportation robot (not shown) loads the substrate W onto and unloads the substrate W off from the supports 3a. After the substrate W is set on the supports 3a with the front side of the substrate W facing up, the regulators 3b are switched to the active state, so that the spin chuck 1 holds the substrate W. This operation of the holding members 3 (regulators 3b) can be realized by means of the link mechanism disclosed in Japanese Patent Application Laid-Open Gazette No. S63-153839 for instance.

The top end of a rotation shaft 4 is attached to the bottom surface of the base member 2. A pulley 5a is fixed to the bottom end of the rotation shaft 4, and rotation drive force of a motor 5 is transmitted to the rotation shaft 4 through a belt 5c which runs between this pulley Sa and another pulley 5b which is fixed to the rotation shaft of the motor 5. Hence, as the motor 5 is driven, the substrate W which is held by the spin chuck 1 rotates about the center of the substrate W.

A nozzle 6 is disposed in a central portion of the base member 2. The nozzle 6 is connected with a solution supplier 50 which supplies the process solution, the rinse solution and the like to the back surface of the substrate through a pipe 7, a pipe 8 and the like which are internally linked along the central axis of the rotation shaft 4 which is hollow. The structure and an operation of the solution supplier 50 will be described later.

An opening 16 is formed in the central portion of the base member 2 such that the opening 16 is coaxial with the nozzle 6. The opening 16 links to a gas supplier 20 through a hollow section 17 created inside the rotation shaft 4 coaxially with the pipe 7, a pipe 19 in which an on-off valve 18 is inserted, etc. Therefore, when the on-off valve 18 is opened, inert gas (nitrogen gas for instance) is supplied between the base member 2 which functions as the “atmosphere blocker” of the present invention and the back surface of the substrate W, whereby this space is purged with an inert gas atmosphere.

Disposed above the spin chuck 1 is a blocking member 21 which functions as the “atmosphere blocker” of the present invention. The blocking member 21 is attached to the bottom end of a suspension arm 22 which is disposed along the vertical direction. A motor 23 is disposed to the top end of the suspension arm 22 so that as the motor 23 is driven, the blocking member 21 rotates about the suspension arm 22. The core of the central axis of the rotation shaft 4 and that of the suspension arm 22 coincide with each other so that the base member 2, the blocking member 21 which function as the atmosphere blocker and the substrate W held by the spin chuck 1 rotates about the same axis. Further, the motor 23 is structured such that the motor 23 rotates the blocking member 21 in the same direction and approximately at the same rotation speed as (the substrate W which is held by) the spin chuck 1.

A nozzle 25 is disposed in a central portion of the blocking member 21. The nozzle 25 is connected with a liquid supplier 70, which supplies the process solution, the rinse solution and the like to the front surface of the substrate, through a pipe 26, a pipe 27 and the like which are internally disposed along the central axis of the suspension arm 22 which is hollow. The structure and an operation of the liquid supplier 70 will be described in detail later.

Further, an opening 35 is formed in the central portion of the central portion of the blocking member 21 in such a manner that the opening 35 is coaxial with the nozzle 25. The opening 35 links to a gas supplying part 39 through a hollow section 36 created inside the suspension arm 22 coaxially with the pipe 26 above, a pipe 38 in which an on-off valve 37 is inserted, etc. Therefore, when the on-off valve 37 is opened with the blocking member 21 located close to the front surface of the substrate W held by the spin chuck 1, inert gas (nitrogen gas for instance) is supplied between the blocking member 21 and the front surface of the substrate W, whereby this space is purged with an inert gas atmosphere. In this embodiment, the hollow sections 17 and 36, the on-off valves 18 and 37, the pipes 19 and 38 and the gas supplying parts 20 and 39 thus form the “inert gas supplier”.

There further is a cup 40 around the spin chuck 1, to thereby prevent the process solution from splashing around. The process solution collected by the cup 40 is discharged outside the apparatus and stored in a tank not shown which is disposed below the cup 40.

The structures of the solution suppliers 50 and 70 will now be described. Since the solution suppliers 50 and 70 have the identical structures, the structure of the solution supplier 50 will be described, whereas the structure of the liquid supplier 70 will be denoted at corresponding reference symbols but will not be denoted. The solution supplier 50 is disposed inside the processing main unit 101, and comprises a hydrofluoric acid source 51 from which hydrofluoric acid is supplied and a hydrochloric acid source 52a from which hydrochloric acid (diluted hydrochloric acid) is supplied. The hydrofluoric acid source 51 is connected with a mixing unit 55 through a pipe 54 in which an on-off valve 53 is inserted, while the pure water supplying unit 200 is connected with the mixing unit 55 through pipes 57 and 201 in which a mixing unit 52b and an on-off valve 56 are inserted. The pure water supplying unit 200 is disposed separately from the processing main unit 101. The mixing unit 52b is connected with the hydrochloric acid source 52a through a pipe 52d in which an on-off valve 52c is inserted so that it is possible to mix hydrochloric acid with pure water which is fed from the pure water supplying unit 200. When the flow rate of hydrochloric acid to mix is controlled, the pH of the mixture solution (pure water+hydrochloric acid) is adjusted to a desired value. Meanwhile, the mixing unit 55 is connected with the nozzle 6 through the pipes 7 and 8 so that it is possible to inject at the nozzle 6 the pH-adjusted mixture solution as a rinse solution toward the substrate W. In this embodiment, as for the back surface of the substrate W, a pH adjustment unit 52 formed by the hydrochloric acid source 52a, the mixing unit 52b, the on-off valve 52c and the pipe 52d functions as the “pH adjustor” of the present invention. Meanwhile, as for the front surface of the substrate W, a pH adjustment unit 72 formed by a hydrochloric acid source 72a, a mixing unit 72b, an on-off valve 72c and a pipe 72d functions as the “pH adjustor” of the present invention.

As the on-off valves 53 and 56 open or close in accordance with a control command received from a controller 80 which controls the apparatus as a whole, a hydrofluoric acid solution or pure water is selectively fed into the pipe 8 from the mixing unit 55 and supplied toward the surfaces (the back surface) of the substrate W. In short, when the on-off valves 53 and 56 are all open, hydrofluoric acid and pure water are fed to the mixing unit 55 and a hydrofluoric acid solution having a predetermined concentration is prepared. This hydrofluoric acid solution is injected out toward the back surface of the substrate W at the nozzle 6 via the pipes 7 and 8, whereby a film adhering to the back surface of the substrate is etched and removed. When the on-off valve 53 is close, the on-off valve 56 is open and the on-off valve 52c is open, and diluted hydrochloric acid is mixed with pure water and thus pH-adjusted mixture solution (pH-adjusted HCL aqueous solution) is supplied as a rinse solution toward the back surface of the substrate W at the nozzle 6 via the pipes 7 and 8 and rinsing is realized. While the pH of the rinse solution is adjusted as the flow rate of hydrochloric acid is controlled depending upon an object to be processed in this example, considering prevention of a rinsing-induced watermark, the pH of the rinse solution is preferably adjusted to 5 or lower.

As described above, with respect to the back surface of the substrate W, along the supply channel (201-57-8-7) which is connected at one end with the nozzle 6, the pH adjustment unit 52 mixes hydrochloric acid with pure water which flows to the nozzle 6 from the pure water supplying unit 200 which is disposed outside the processing main unit 101, so that the pH of the mixture solution is adjusted. The pH-adjusted mixture solution is then supplied as the rinse solution toward the back surface of the substrate W at the nozzle 6 and rinsing is achieved. In a similar fashion, as for the front surface of the substrate W, along the supply channel (201-77-27-26) which is connected at one end with the nozzle 25, the pH adjustment unit 72 mixes hydrochloric acid with pure water which flows to the nozzle 25 from the pure water supplying unit 200 which is disposed outside the processing main unit 101, so that the pH of the mixture solution is adjusted. The pH-adjusted mixture solution is then supplied as the rinse solution toward the front surface of the substrate W at the nozzle 25 and rinsing is achieved.

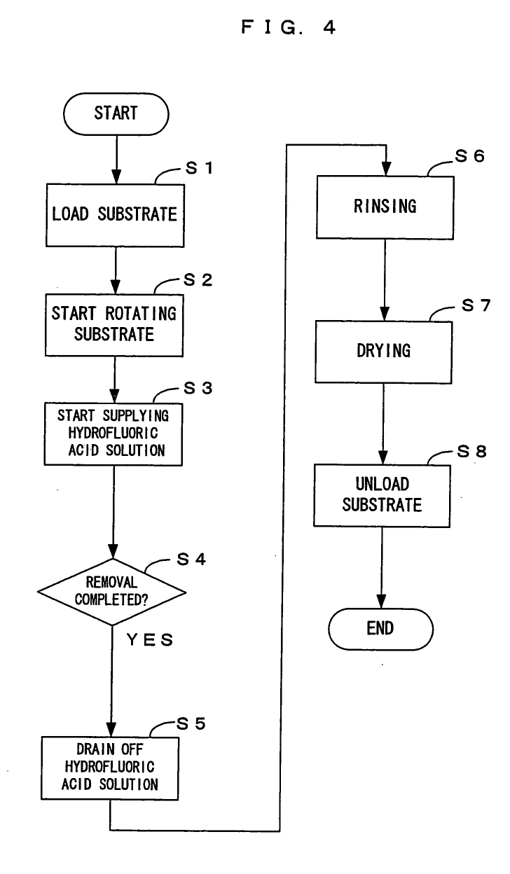

An operation of the substrate processing system having the structure above will now be described with reference to FIG. 4. FIG. 4 is a flow chart which shows the operation of the substrate processing system which is shown in FIG. 2. In the substrate processing apparatus 100, the transportation robot transports an unprocessed substrate W to the spin chuck 1, and after the holding members 3 have held the substrate (Step S1), the respective sections of the apparatus execute film removal, rinsing and drying in this order under the control of the controller 80 which controls the entire apparatus.

At Step S2, after the blocking member 21 has moved close to the front surface of the substrate W which is held by the spin chuck 1, the motor 5 starts driving while the substrate W is held between the base member 2 and the blocking member 21, and the substrate W consequently rotates together with the spin chuck 1. The on-off valves 53, 73, 56 and 76 are all opened, thereby supplying hydrofluoric acid and pure water to the mixing units 55 and 75, creating a hydrofluoric acid solution having a predetermined concentration, and feeding this hydrofluoric acid solution under pressure to the nozzles 6 and 25. Supply of the hydrofluoric acid solution toward the both surfaces of the substrate W at the nozzles 6 and 25 is thus started (Step S3). This initiates etching of films adhering to the both surfaces of the substrate W. In this embodiment, the film removal step thus corresponds to the “wet processing step” of the present invention.

Upon confirmation at Step S4 of the end of film removal, the on-off valves 53, 73, 56 and 76 are all closed, and after stopping the supply of the hydrofluoric acid solution toward the substrate W at the nozzles 6 and 25, the substrate W is rotated at a high speed and the hydrofluoric acid solution is drained off and discharged outside the apparatus.

As the hydrofluoric acid solution is drained off (Step S5), the on-off valves 18 and 37 are opened and inert gas is supplied to the space which is created between the substrate W and the base member 2 and between the substrate W and the blocking member 21. After the ambient atmosphere of the substrate W has been changed to an inert gas atmosphere, as the on-off valves 56 and 76 are opened and the on-off valves 52c and 72c are opened, a predetermined amount of hydrochloric acid is mixed with pure water and the mixture solution whose pH is adjusted to a predetermined value which is equal to or smaller than 5 is created as the rinse solution (which corresponds to the “rinse solution creating step” of the present invention). This rinse solution (pH-adjusted HCL aqueous solution) is supplied to the both major surfaces of the substrate W, and the substrate W is rinsed (which corresponds to the “rinsing step” of the present invention) (Step S6). After rinsing, the on-off valves 56, 76, 52c and 72c are then closed and the substrate W is kept rotating until the substrate W dries up, whereby drying is achieved (Step S7). The Step S7 for drying of the substrate W corresponds to the “drying step” of the present invention. After drying of the substrate W, the substrate W is stopped rotating, the on-off valves 18 and 37 are closed and the supply of the inert gas is stopped.

Since the ambient atmosphere of the substrate W is the inert gas atmosphere during execution of rinsing and drying, it is possible to reduce the amount of oxygen around the substrate W which can be dissolved in the rinse solution. Hence, it is possible to further suppress an increase of dissolved oxygen in the rinse solution during the period (which may be about 30 seconds for example) since ejection of the rinse solution toward the substrate W at the nozzles 6 and 25 until removal of the rinse solution off from the substrate W.

As the series of substrate processing (film removal, rinsing and drying) completes in this manner, the blocking member 21 moves away from the front surface of the substrate W which is held by the spin chuck 1, the holding members 3 releases the substrate, and the transportation robot transports thus processed substrate W to the next substrate processing apparatus (Step S8).

As described above, in this embodiment, since the substrate W is rinsed with the mixture solution whose pH has been reduced down to 5 or lower by mixing diluted hydrochloric acid with pure water, it is possible to reduce elution of Si from the substrate W and prevent creation of a watermark. This prevents inconveniences against film deposition such as an increased contact resistance and a pattern defect. This also effectively prevents charging of the substrate W during rinsing.

To be noted in particular, since this embodiment uses diluted hydrochloric acid as the pH adjustor substance for the rinse solution, the following effect is obtained. That is, due to the powerful ionization of diluted hydrochloric acid, addition of an extremely small amount of diluted hydrochloric acid reduces the pH of the rinse solution, which easily attains adjustment of the pH of the rinse solution and reduces running costs.

The amount of diluted hydrochloric acid contained in the rinse solution is extremely small, and in addition, no unwanted substance will not remain on the substrate W after processing. For instance, if sulfuric acid is used as the pH adjustor substance, sulfides will be left on a substrate and could be detected as particles. Meanwhile, use of nitric acid as the pH adjustor substance may oxidize the surfaces of a substrate. However, when diluted hydrochloric acid is used as the pH adjustor substance, it is possible to perform high-quality rinsing while avoiding such inconveniences.

### Second Embodiment

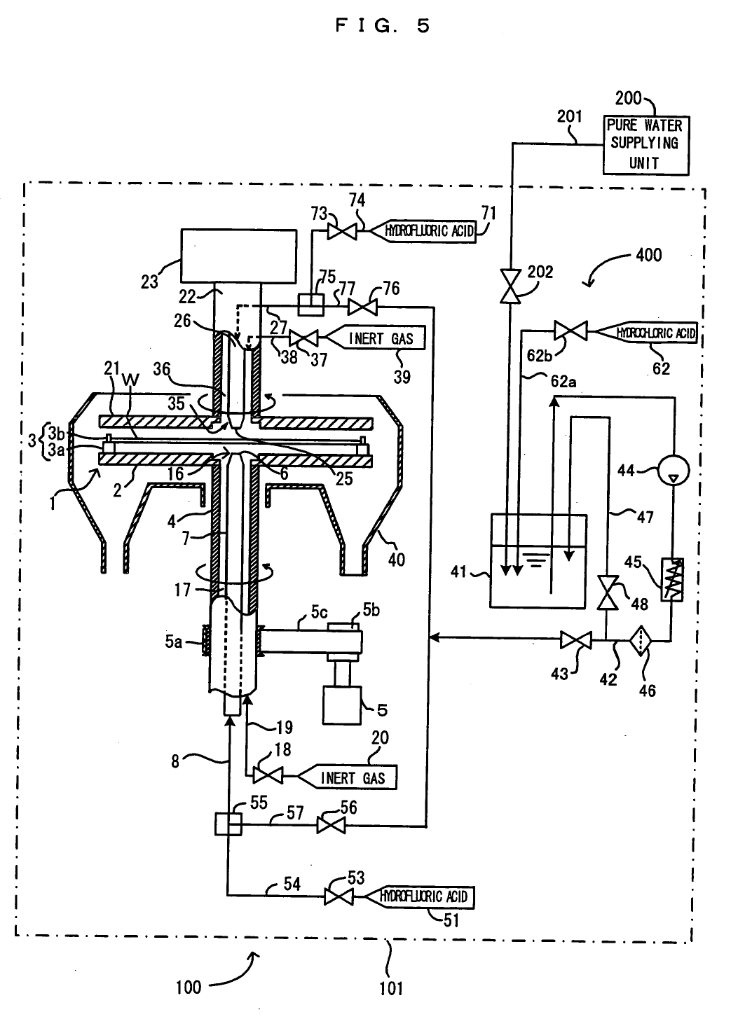

FIG. 5 is a drawing which shows the second embodiment of the substrate processing system according to the present invention. A major difference of the second embodiment from the first embodiment is that while the first embodiment requires mixing at the mixing units 52b and 72b hydrochloric acid (diluted hydrochloric acid) directly with pure water which flows in the pipes 57 and 77 to thereby create the rinse solution, hydrochloric acid is mixed with pure water inside a storage tank 41 will be described later in the second embodiment. This structure has the following advantages. That is, the first embodiment utilizes in-line mixing of hydrochloric acid with pure water, and therefore, it is difficult to control the flow rate of hydrochloric acid and finely adjust the pH of the rinse solution. This is because adjustment of the pH of the rinse solution to a desired value necessitates controlling a small amount of hydrochloric acid. On the contrary, in the second embodiment, hydrochloric acid is mixed with pure water, the pH of the mixture solution is consequently adjusted and some (or all) of the pH-adjusted mixture solution is then taken out, which makes it easy to finely adjust the pH of the rinse solution.

As shown in FIG. 5, pure water from the pure water supplying unit 200 which is disposed outside the processing main unit 101 is supplied to a cabinet 400. Although such a cabinet 400 is often used to combine plural types of chemicals with pure water for creation of process solutions, this embodiment uses the cabinet 400 to create the rinse solution which is the mixture of pure water and hydrochloric acid. The cabinet 400 comprises a storage tank 41 in which the mixture solution of pure water and hydrochloric acid is stored, and the pipe 201 which is for supplying pure water into the storage tank 41 is attached at one end to the storage tank 41 and links via an on-off valve 202 at the other end to the pure water supplying unit 200 which is disposed separately from the processing main unit 101. A pipe 62a which is for supplying hydrochloric acid into the storage tank 41 is attached at one end to the storage tank 41 and links via an on-off valve 62b at the other end to a hydrochloric acid source 62.

The storage tank 41 accepts the other end of a supply pipe 42 whose one end is connected with the pipes 57 and 77, so that it is possible to supply the mixture solution held inside the storage tank 41 toward the nozzles 6 and 25. In short, the supply pipe 42 is connected with the branch pipes 57 and 77, in which the on-off valves 56 and 76 are inserted, via the on-off valve 43 and links to the nozzles 6 and 25. Disposed to the supply pipe 42 are a metering pump 44 which pumps out the mixture solution stored in the storage tank 41 to the supply pipe 42, a temperature controller 45 which adjusts the temperature of the mixture solution pumped out to the supply pipe 42 by the metering pump 44, and a filter 46 which removes an impurity and the like contained in the mixture solution.

Between the on-off valve 43 and the filter 46 of the supply pipe 42, a circulating pipe 47 branching off from the supply pipe 42 is installed. Hence, the mixture solution pumped out by the metering pump 44 returns via the circulating pipe 47 after flowing through the temperature controller 45 and the filter 46, and thus the mixture solution circulates. An on-off valve 48 is inserted in the circulating pipe 47, and therefore, when the on-off valve 48 is open and the on-off valve 43 is close, the mixture solution circulates. On the other hand, when the on-off valve 43 is open and the on-off valve 48 is close, the mixture solution is supplied to the nozzles 6 and 25.

In the substrate processing system having this structure, as pure water from the pure water supplying unit 200 and hydrochloric acid from a hydrochloric acid source 62 are mixed together inside the storage tank 41, the mixture solution whose pH is adjusted to a predetermined value which is equal to or smaller than 5 is created. The temperature of thus pH-adjusted mixture solution is adjusted as the on-off valve 48 is opened with the on-off valve 43 closed, and the mixture solution circulates while removing an impurity and the like from the mixture solution. When the on-off valve 43 is open and the on-off valve 48 is close, the pH-adjusted mixture solution is fed into the branch pipes 57 and 77. As the on-off valves 56 and 76 are opened additionally, the mixture solution whose pH has been adjusted to 5 or lower is supplied at the nozzles 6 and 25 to the both major surfaces of the substrate W as the rinse solution and the substrate W is rinsed.

As described above, in this embodiment, with respect to the back surface of the substrate W, along the supply channel (201—storage tank 41-42-57-8-7) which is connected at one end with the nozzle 6, hydrochloric acid is mixed inside the storage tank 41 with pure water which flows toward the nozzle 6 from the pure water supplying unit 200 which is disposed outside the processing main unit 101, thereby adjusting the pH of the mixture solution (pure water+hydrochloric acid). Thus pH-adjusted mixture solution is then supplied as the rinse solution at the nozzle 6 to the back surface of the substrate W, and rinsing is achieved. In a similar fashion, as for the front surface of the substrate W, along the supply channel (201—storage tank 41-42-77-27-26) which is connected at one end with the nozzle 25, the pH of the mixture solution is adjusted inside the storage tank 41, and this mixture solution is then supplied as the rinse solution at the nozzle 25 to the front surface of the substrate W, thereby realizing rinsing.

As described above, in this embodiment as well, since the mixture solution whose pH has been adjusted to 5 or lower by mixing diluted hydrochloric acid with pure water is used as the rinse solution, similar effects to those according to the first embodiment are achieved. That is, suppressed elution of Si from a substrate W prevents creation of a watermark. Further, since the mixture solution is stored temporarily within the storage tank 41 and the pH of the rinse solution is then adjusted, it is easy to finely adjust the pH of the rinse solution.

### Third Embodiment

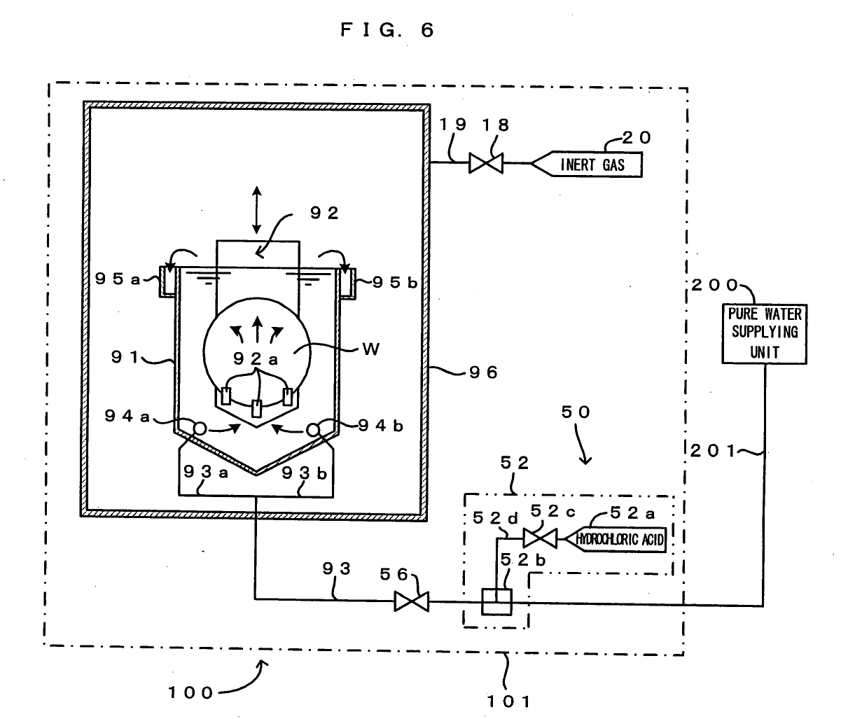

FIG. 6 is a drawing of the third embodiment of the substrate processing system according to the present invention. A major difference of the third embodiment from the first embodiment is that the third embodiment is directed to so-called batch processing in which a plurality of substrates W are processed at once, whereas the first embodiment is directed to so-called single water processing in which one substrate W is processed at a time. For the purpose of executing the series of substrate processing (film removal using a process solution, rinsing and drying) on a plurality of substrates W, a substrate processing apparatus of the batch type comprises a film removal bath, a rinsing bath and a drying bath. The film removal bath holds a process solution such as an etchant (hydrofluoric acid solution, etc.) and is for removal of films from the substrates. The rinsing bath holds pure water which serves as a rinse solution and is for rinsing of the substrates W. The drying bath is for spin-drying or otherwise drying the substrates W. FIG. 6 shows the substrate processing system relevant to rinsing among these.

In the rinsing bath 91 shown in FIG. 6, after film removal in the film removal bath, rinsing is performed which is to wash away the process solution adhering to the surfaces of the substrates W, associated particles, etc. To be more specific, the plurality of substrates W processed in the film removal bath are transferred to a lifter apparatus 92 whose three arms 92a are capable of holding the substrates W and the lifter apparatus 92 descends inside the rinsing bath 91, so that the plurality of substrates W are immersed in the rinse solution. In the rinsing bath 91, pure water which serves as the rinse solution is injected, before supplied at the bottom of the bath, toward the center of the substrates at two rinse solution supplying members 94a and 94b, which are disposed one on the right and the other on the left such that they are parallel to each other in the bottom of the bath, via a pipe 93 which is for supplying the rinse solution and branch pipes 93a and 93b of the pipe 93. The paired rinse solution supplying members 94a and 94b comprise multiple of nozzles (not shown) which are disposed one each between the substrates W and at which the rinse solution is injected from bottom right and bottom left to the substrates W which are immersed in the process solution. The jets of the rinse solution coming from these nozzles each between the substrates W keep flying upward as upflows in a central area of the bath after injected on the both sides, one on the right and the other on the left, and flow out over the top opening of the bath. Utilizing the overflow, contaminants such as particles created by the process solution are collected, together with the process solution and the pure water, by overflow baths 95a and 95b and discharged to outside the baths.

The structure of the solution supplier 50 will now be described. The structure of the solution supplier 50 is basically similar to that according to the first embodiment, except for that it lacks the hydrofluoric acid supply system which is for supplying hydrofluoric acid as the process solution (the hydrofluoric acid supply system is disposed to the film removal bath). In short, the pure water supplying unit 200 which is disposed outside the processing main unit 101 is connected with the rinse solution supplying members 94a and 94b via a pipe 201, the pipe 93 and the branch pipes 93a and 93b. In the pipe 93, the on-off valve 56 and the mixing unit 52b are inserted. Further, the mixing unit 52b is connected with the hydrochloric acid source 52a via the pipe 52d in which the on-off valve 52c is inserted, so that it is possible to mix hydrochloric acid (diluted hydrochloric acid) with pure water which is supplied from the pure water supplying unit 200. Hence, as the on-off valve 52c is adjusted, hydrochloric acid is mixed with pure water and the pH of the mixture solution is adjusted. When the on-off valve 52c is opened with the on-off valve 56 open, the mixture solution whose pH has been adjusted to 5 or lower is supplied as the rinse solution to each substrate W which has been set inside a rinsing bath 91.

In this manner, the pH adjustment unit 52 mixes hydrochloric acid in pure water which flows toward the nozzle from the pure water supplying unit 200 along the supply channel (201-93-93a or 201-93-93b) which is connected at one end with the nozzle disposed to the rinse solution supplying members 94a and 94b, thereby adjusting the pH of the mixture solution in this embodiment. The pH-adjusted mixture solution is then supplied as the rinse solution to each substrate W at the nozzle and rinsing is performed.

Further, the rinsing bath 91 is housed in a hermetic structure 96, and the gas supplier 20 links to the hermetic structure 96 via the pipe 19 in which the on-off valve 18 is inserted. Hence, when the on-off valve 18 is open, inert gas (such as nitrogen) is supplied inside the hermetic structure 96 so that the area around the rinsing bath 91 is filled with the inert gas and purged at an exhaust vent not shown.

As described above, in this embodiment, the mixture solution whose pH has been decreased to 5 or lower by mixing diluted hydrochloric acid with pure water is supplied as the rinse solution to multiple substrates W which have been set inside the rinsing bath 91, and therefore, similar effects to those according to the first embodiment are achieved. That is, suppressed elution of Si from each substrate W prevents creation of watermarks.

Further, since the area around the rinsing bath 91 is changed to the inert gas atmosphere, it is possible to reduce the amount of oxygen which gets dissolved in the rinse solution and therefore suppress an increase of dissolved oxygen in the rinse solution, and it is possible to prevent oxidation which is associated with loading and unloading of substrates W to and from the rinsing bath 91. This suppresses elution of Si from each substrate W and more effectively prevents creation of watermarks.

<Effect of Dissolved Nitrogen in Rinse Solution>

The effect of dissolution of nitrogen in the rinse solution will now be described. To be more specific, diluted hydrochloric acid is mixed with two types of liquids, one in which nitrogen has been dissolved (hereinafter referred to as “nitrogen-dissolved water”) and the other in which nitrogen has not been dissolved (which is deaerated pure water available from plant water and which will be hereinafter referred to as “facility supply water”), and pH-adjusted rinse solutions (having pH of 3, 4 and 5) are created. Watermarks which are created during substrate processing with thus created rinse solutions are confirmed and the effect of dissolved nitrogen is studied.

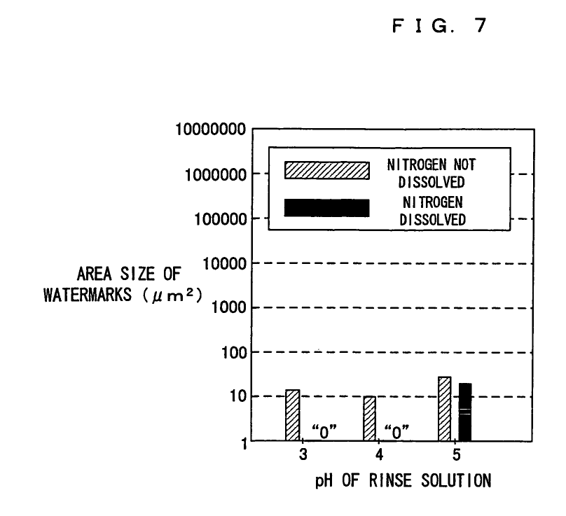

FIG. 7 is a graph which shows a relationship between whether nitrogen has been dissolved and the area size of watermarks. The test results shown in FIG. 7 are obtained in a similar fashion to that for obtaining the test results shown in FIG. 1. As clearly shown in FIG. 7, as for any pH level among pH 3, 4 and 5, the rinse solutions in which nitrogen has been dissolved (i.e., the rinse solutions created from nitrogen-dissolved water which are denoted in FIG. 7 as “NITROGEN-DISSOLVED”) create watermarks in smaller area sizes than the rinse solutions in which nitrogen has not been dissolved (i.e., the rinse solutions created from facility supply water which are denoted in FIG. 7 as “NO-NITROGEN”) do. In FIG. 7, to be noted in particular, the area size of watermarks is “0” (the same or less than the limit of detection) in the case of processing with the nitrogen-dissolved rinse solutions having pH of 3 and 4. This shows dissolution of nitrogen in a rinse solution and a reduction of dissolved oxygen in the rinse solution suppress elution of Si from a substrate. In this manner, by means of adjustment of the pH of a rinse solution and dissolution of nitrogen, it is possible to more effectively prevent creation of a watermark.

<Relationship Between pH of Rinse Solution, Dissolved Oxygen Concentration and Si Elution>

To study the influence of the pH and the dissolved oxygen concentration of a rinse solution over creation of an oxide film and a watermark, the inventor of the invention prepared two types of rinse solutions having different dissolved oxygen concentrations, and evaluated elution of Si from an Si substrate while changing the pH of each rinse solution.

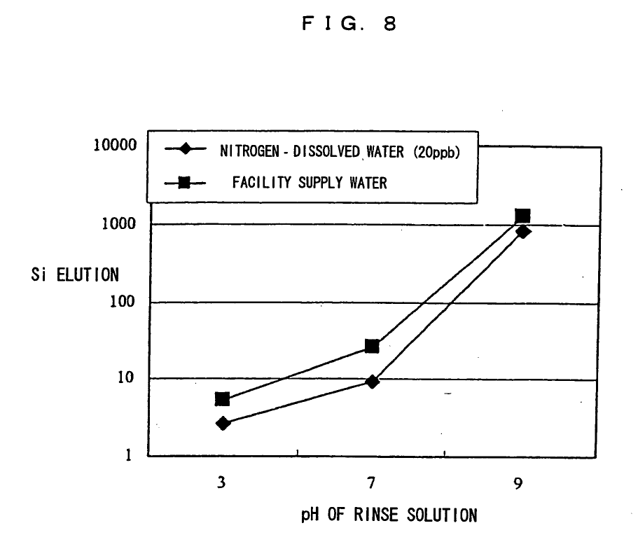

FIG. 8 is a graph which shows a relationship between the pH of the rinse solution and elution of Si associated with the amount of dissolved oxygen. More specifically, rinse solutions which are different from each other in pH were created using two types of pure water, one of which is a nitrogen-dissolved water and the other of which is a facility supply water. Elution of Si into each rinse solution was calculated, and the results are as depicted in the graph. The results shown in FIG. 8 were obtained in the following manner. First, for the respective rinse solutions, Si substrates (poly-Si substrates having the diameter of 200 mm) similarly treated with HF were set in containers. Following this, three rinse solutions (100 cc) different from each other in pH created each from nitrogen-dissolved water (the amount of dissolved nitrogen: 20 ppb) and facility supply water were paddled over the Si substrates which were set in the containers. After the elution time of five minutes, the rinse solutions were collected off from the substrates for each container. Using the frameless atomic absorption spectrometer (FL-AAS Varian Spectr AA880Z) available from Varian, elution of Si in each one of thus collected rinse solutions was measured and elution of Si in each rinse solution was found.

As FIG. 8 clearly shows, independently of the pH, elution of Si from the surfaces of the substrates is smaller in the rinse solutions in which nitrogen has been dissolved (i.e., the rinse solutions created from nitrogen-dissolved water) than in the rinse solutions in which nitrogen has not been dissolved (i.e., the rinse solutions created from facility supply water). In other words, dissolution of nitrogen in the rinse solution lowers the dissolved oxygen concentration in the rinse solution and hence suppresses elution of Si. FIG. 8 also indicates that the higher the pH of the rinse solution is (the alkaline region), the faster the Si substrate gets etched and the larger the amount of elution of Si from the surfaces of the substrate becomes. Hence, use of a low-pH rinse solution suppresses elution of Si. It is therefore concluded that use of a low-pH rinse solution in which nitrogen has been dissolved effectively suppress elution of Si.

Combination of pH reduction of the rinse solution and dissolution of nitrogen in the rinse solution brings about the following advantage. That is, while the lower pH of the rinse solution further suppresses elution of Si from the surfaces of a substrate, when the pH is too low, corrosion of the substrate occurs. In short, although there is a limit in lowering the pH of the rinse solution, dissolution of nitrogen in the rinse solution and consequent reduction of the amount of dissolved oxygen in the rinse solution suppresses elution of Si to such an extent that is impossible with low pH alone because of corrosion. Use of such a rinse solution thus prevents creation of an oxide film in a substrate, effectively suppresses elution of Si from the surfaces of the substrate, and prevents creation of a watermark.

As for a method of reducing the amount of dissolved oxygen in a rinse solution, besides dissolution of nitrogen in the rinse solution, the rinse solution may be deaerated to reduce dissolved oxygen in the rinse solution. Use of a deaerated rinse solution in addition to lowering of the pH of the rinse solution prevents creation of an oxide film in the substrate and effectively suppresses elution of Si from the surfaces of the substrate.

In light of the above, adjustment of the pH of a rinse solution may be combined with reduction of dissolved oxygen to thereby prevent creation of an oxide film, a watermark and the like in a substrate. Embodiments of the present invention will now be described specifically with reference to the associated drawings.

### Fourth Embodiment

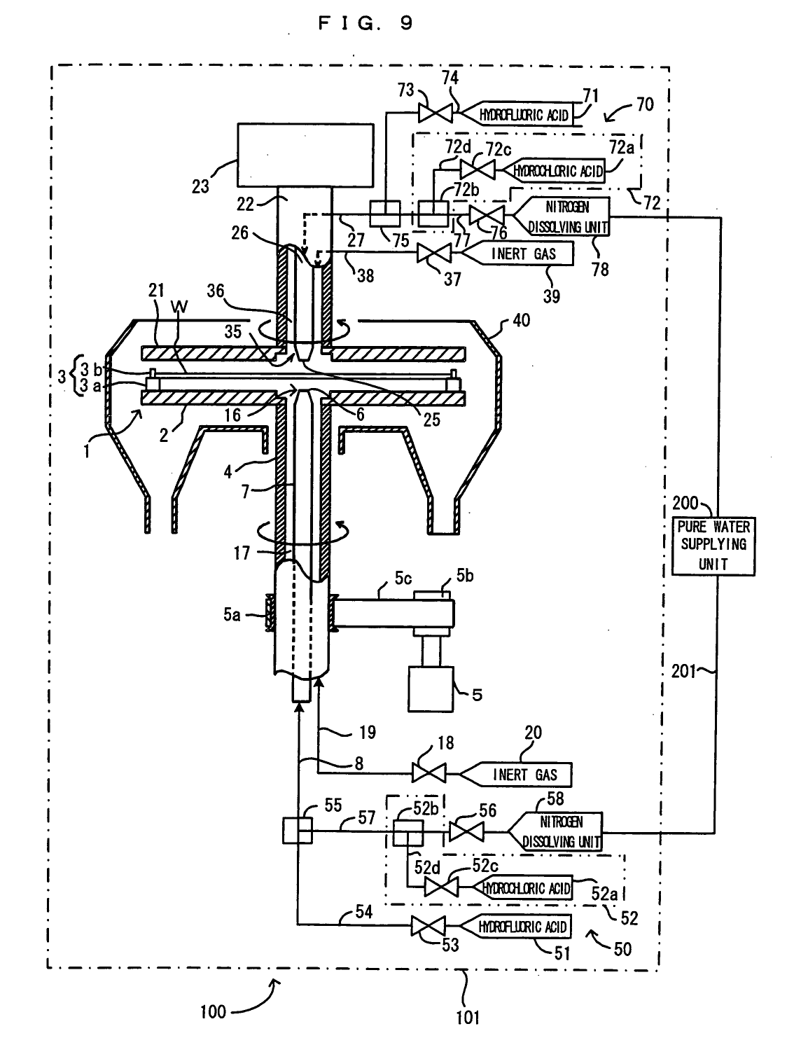

FIG. 9 is a drawing which shows the structure of the substrate processing system according to the fourth embodiment of the present invention. A major difference of the fourth embodiment from the first embodiment is that while hydrochloric acid (diluted hydrochloric acid) is mixed with pure water and the resulting pH-adjusted mixture solution is used as a rinse solution in the first embodiment, nitrogen is dissolved in pure water, hydrochloric acid is mixed with this nitrogen-dissolved pure water and the pH-adjusted nitrogen-rich fluid is used as a rinse solution in the fourth embodiment. The solution suppliers 50 and 70 have the identical structures, and therefore, the structure of the solution supplier 50 will be described, whereas the structure of the liquid supplier 70 will be denoted at corresponding reference symbols but will not be denoted.

In this embodiment, the solution supplier 50 comprises a hydrofluoric acid source 51 from which hydrofluoric acid is supplied, a hydrochloric acid source 52a from which hydrochloric acid (which corresponds to the “low-pH substance” of the present invention) is supplied and a nitrogen dissolving unit 58. The nitrogen dissolving unit 58 may be a bubbling apparatus equipped with a tank, a conventional apparatus which uses a hollow yarn, etc. The hydrofluoric acid source 51 is connected with a mixing unit 55 through a pipe 54 in which an on-off valve 53 is inserted, while the pure water supplying unit 200 disposed separately from the processing main unit 101 is connected with an inlet of the nitrogen dissolving unit 58 through a pipe 201. The nitrogen dissolving unit 58 comprises another inlet and is connected with a nitrogen gas source not shown. Nitrogen gas from the nitrogen gas source is dissolved in pure water supplied from the pure water supplying unit 200, and nitrogen-rich pure water is created. An outlet of the nitrogen dissolving unit 58 is connected with the mixing unit 55 through a pipe 57 in which an on-off valve 56 and a mixing unit 52b are inserted. The mixing unit 52b is connected with the hydrochloric acid source 52a through a pipe 52d in which an on-off valve 52c is inserted, so that it is possible to mix hydrochloric acid in pure water supplied from the nitrogen dissolving unit 58 in which nitrogen has been dissolved. As the flow rate of hydrochloric acid to mix is controlled, the pH of the mixture solution (pure water+hydrochloric acid) in which nitrogen has been dissolved is adjusted. Meanwhile, the mixing unit 55 is connected with the nozzle 6 through the pipes 7 and 8, so that it is possible to inject at the nozzle 6 the nitrogen-dissolved pH-adjusted mixture solution as the rinse solution toward the substrate W.

As the on-off valves 53 and 56 are switched on or off in accordance with a control command received from a controller 80 which controls the apparatus as a whole, a hydrofluoric acid solution or nitrogen-dissolved pure water is selectively fed into the pipe 8 from the mixing unit 55 and supplied toward the back surface of the substrate W. In other words, when the on-off valves 53 and 56 are all open, hydrofluoric acid and pure water are supplied to the mixing unit 55 and a hydrofluoric acid solution having a predetermined concentration is created. This hydrofluoric acid solution is injected out toward the back surface of the substrate W at the nozzle 6 via the pipes 7 and 8, whereby a film adhering to the back surface of the substrate is etched and removed. When the on-off valve 53 is close, the on-off valve 56 is open and the on-off valve 52c is open, the nitrogen-dissolved pH-adjusted rinse solution is supplied toward the back surface of the substrate W at the nozzle 6 via the pipes 7 and 8 and rinsing is realized. It is noted that the pH of the rinse solution is adjusted as the flow rate of hydrochloric acid is controlled depending upon an object to be processed. In the event that an object to be processed is an Si substrate, the pH of the rinse solution is adjusted from 2 to 6, or more preferably 5 or lower, for the purpose of suppressing elution of Si and in light of corrosion. In this embodiment, the nitrogen dissolving units 58 and 78 thus correspond to the “nitrogen dissolver” of the present invention.

The substrate processing system having this structure as well executes a series of substrate processing (film removal, rinsing and drying) in the operation sequence shown in FIG. 4. In other words, as the hydrofluoric acid solution is drained off (Step S5), the on-off valves 18 and 37 are opened and inert gas is supplied to the space which is created between the substrate W and the base member 2 and between the substrate W and the blocking member 21. After the ambient atmosphere of the substrate W has been changed to an inert gas atmosphere, as the on-off valves 56 and 76 are opened and the on-off valves 52c and 72c are opened, the nitrogen-dissolved pH-adjusted rinse solution is created, this rinse solution is supplied to the both major surfaces of the substrate W, and the substrate W is rinsed (Step S6). After rinsing, the on-off valves 56, 76, 52c and 72c are closed and the substrate W is kept rotating until the substrate W dries. After drying of the substrate W, the substrate W is stopped rotating, the on-off valves 18 and 37 are closed and the supply of the inert gas is stopped (Step S7).

As described above, in this embodiment, the substrate W is rinsed with the nitrogen-dissolved pH-adjusted rinse solution. In this manner, it is possible to dissolve nitrogen in the rinse solution and accordingly reduce dissolved oxygen in the rinse solution, and it is possible to further suppress elution of Si from the surfaces of a substrate. Hence, adjustment of the pH of the rinse solution and dissolution of nitrogen reduce elution of Si from the substrate W and further effectively prevent rinsing-induced creation of a watermark.

In this embodiment, reduction of the pH and the dissolved oxygen concentration of the rinse solution suppresses elution of Si brings about the following advantages. That is, lowering of the pH of the rinse solution must be limited so as to avoid corrosion of the substrate W. On the other hand, the low dissolved oxygen concentration in the rinse solution suppresses elution of Si to such an extent that is impossible with low pH alone because of corrosion. It is therefore possible to prevent creation of an oxide film in the substrate W, effectively suppress elution of Si from the surfaces of the substrate and avoid creation of a watermark.

Further, since nitrogen has been dissolved in the rinse solution, the dissolved oxygen concentration in the rinse solution is reduced and a rapid increase of the dissolved oxygen concentration in the rinse solution is effectively suppressed during the period (which may be 30 seconds for example) since injection of the rinse solution toward the substrate W at the nozzles 6 and 25 until the end of drying (i.e., until removal of the rinse solution from the substrate W). In addition, the low dissolved oxygen concentration in the rinse solution further suppresses elution of Si from the surfaces of the substrate.

More further, since the ambient atmosphere around the substrate W is changed to the inert gas atmosphere during execution of rinsing and drying, it is possible to reduce the amount of oxygen around the substrate W which can be dissolved in the rinse solution. Hence, it is possible to further suppress an increase of the dissolved oxygen concentration in the rinse solution during the period since injection of the rinse solution toward the substrate W at the nozzles until removal of the rinse solution from the substrate W. This more effectively suppresses creation of an oxide film, a watermark and the like in the substrate W.

Still further, in this embodiment, since the nitrogen dissolving units 58 and 78 are disposed inside the processing main unit 101, the distribution channel starting with creation of the rinse solution and ending with injection of the rinse solution at the nozzles 6 and 25 is shortened. The rinse solution is therefore supplied to the substrate W soon after created, attaining supply of the rinse solution to the substrate W and rinsing of the substrate W while the effect of dissolved nitrogen lasts. An increase of the dissolved oxygen concentration in the rinse solution is consequently more effectively suppressed.

### Fifth Embodiment

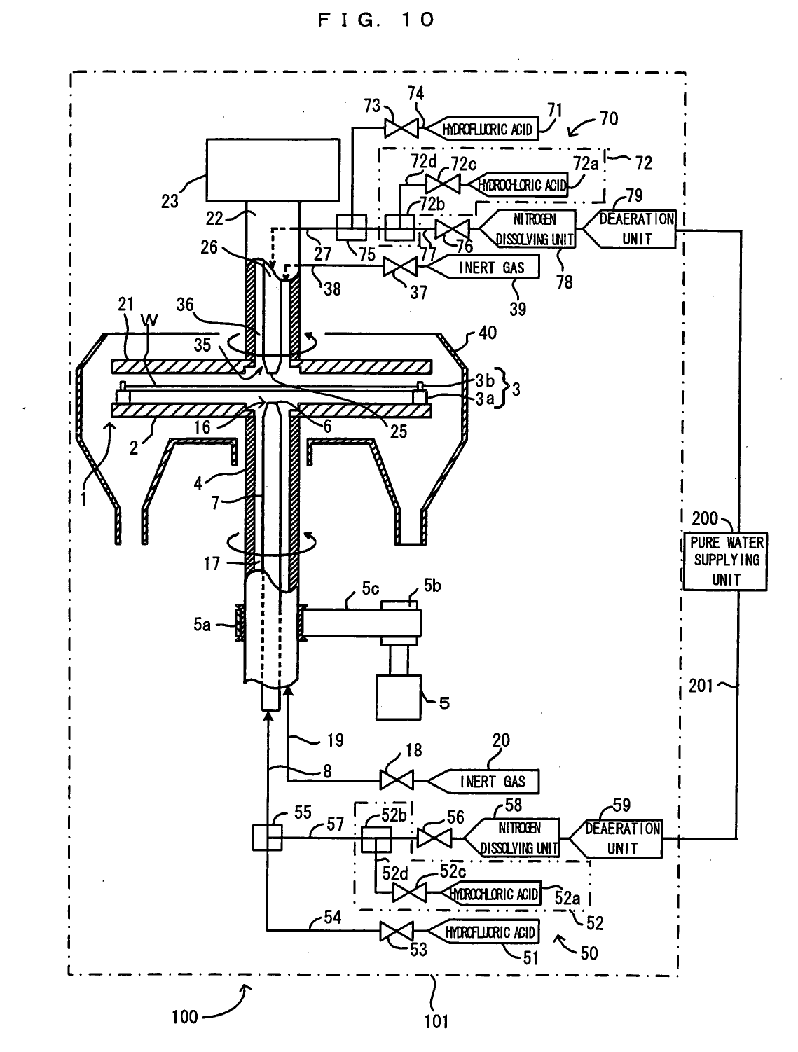

FIG. 10 is a drawing which shows the structure of a substrate processing system according to the fifth embodiment of the present invention. A major difference of the fifth embodiment from the fourth embodiment is that while pure water available from plant water in a factory where the substrate processing apparatus 100 is installed is fed directly to the nitrogen dissolving units 58 and 78 and the rinse solution is created in the fourth embodiment, pure water is deaerated in deaeration units 59 and 79 and then immediately fed to the nitrogen dissolving units 58 and 78 to create the rinse solution in the fifth embodiment. In the fifth embodiment, the deaeration units 59 and 79 corresponding to the “deaerator” of the present invention is disposed additionally in the processing main unit 101. In short, the deaeration unit 59 is additionally disposed to the nitrogen dissolving unit 58 on the other end side of the supply channel (201-57-8-7) which is connected at one end with the nozzle 6 for the back surface of the substrate W, whereas the deaeration unit 79 is additionally disposed to the nitrogen dissolving unit 78 on the other end side of the supply channel to the supply channel (201-77-27-26) which is connected at one end with the nozzle 25 for the front surface of the substrate W. The following effect is achieved further.

A current practice implemented in a factory where the substrate processing apparatus 100 is installed is deaeration of pure water at a deaeration facility adjacent to the factory, to thereby reduce the dissolved oxygen concentration in the pure water. Thus deaerated pure water is supplied to a plant water line (pipe 201) of the factory. However, oxygen gets dissolved in this pure water before the pure water reaches the substrate processing apparatus 100 via the plant water line from the deaeration facility and the dissolved oxygen concentration in the pure water starts rising immediately after deaeration. In contrast, the deaeration units 59 and 79 are disposed adjacent to the nitrogen dissolving units 58 and 78 in this embodiment. Hence, since pure water whose dissolved oxygen concentration has become low through deaeration at the deaeration units 59 and 79 (corresponding to the “deaeration step” of the present invention) is immediately supplied to the nitrogen dissolving units 58 and 78, the rinse solution whose dissolved oxygen concentration is lower than in the fourth embodiment is obtained.

As described above, in this embodiment, since nitrogen is dissolved in pure water which has just been deaerated, it is possible to create a rinse solution whose dissolved oxygen concentration is lower than in the fourth embodiment. In consequence, this even more effectively suppresses creation of an oxide film, a watermark and the like in the substrate W.

Further, in the fifth embodiment, since the deaeration units 59 and 79 are disposed together with the nitrogen dissolving units 58 and 78 inside the processing main unit 101, a short distribution channel is attained which starts with deaeration of pure water, dissolution of nitrogen in the pure water and creation of the pH-adjusted rinse solution and which ends with injection of the rinse solution at the nozzles 6 and 25 is shortened. This ensures quick supply of thus created rinse solution to the substrate W, thereby more effectively suppressing an increase of the dissolved oxygen concentration in the rinse solution.

### Sixth Embodiment

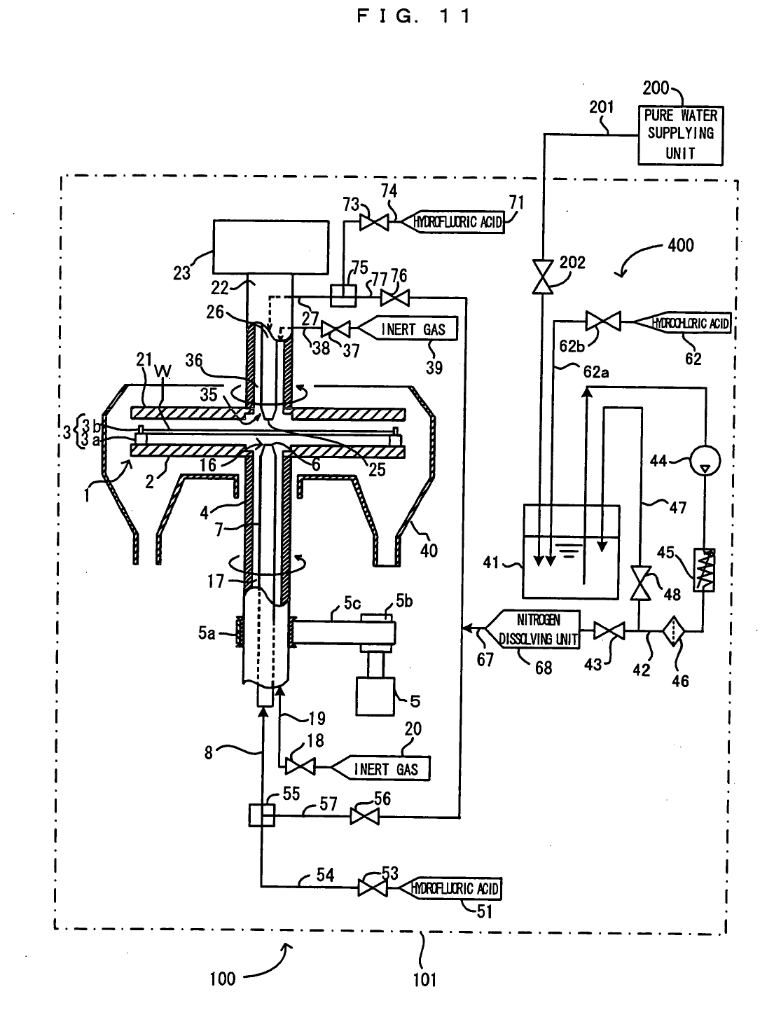

FIG. 11 is a drawing which shows the structure of the substrate processing system according to the sixth embodiment of the present invention. A major difference of the sixth embodiment from the second embodiment is that a nitrogen dissolving unit 68 is additionally equipped with the substrate processing apparatus 100. More specifically, while hydrochloric acid (diluted hydrochloric acid) is mixed with pure water and the resulting pH-adjusted mixture solution is used as a rinse solution in the second embodiment, nitrogen is further dissolved in the mixture solution (pure water+hydrochloric acid) and the resulting pH-adjusted nitrogen-rich fluid is used as a rinse solution in the sixth embodiment. Other structures are basically similar to those according to the second embodiment, and therefore, differences will be mainly described below.

A supply pipe 42, which is connected at one end with the inlet of the nitrogen dissolving unit 68, is inserted at the other end to the storage tank 41 so that it is possible to supply the mixture liquid stored in the storage tank 41 to the nitrogen dissolving unit 68 via an on-off valve 43. An outlet of the nitrogen dissolving unit 68 is connected with a pipe 67 which links to the nozzles 6 and 25 respectively via branch pipes 57 and 77 in which the on-off valves 56 and 76 are inserted.

In the substrate processing system having this structure, pure water from the pure water supplying unit 200 and hydrochloric acid from the hydrochloric acid source 62 are mixed together inside the storage tank 41, and the mixture solution whose pH is adjusted to a predetermined pH level (i.e., a predetermined pH value which is 2 through 6 or more preferably 5 or lower) is created. As the on-off valve 48 is opened with the on-off valve 43 closed, the temperature of thus pH-adjusted mixture solution is adjusted and the mixture solution circulates while removing an impurity and the like from the mixture solution. When the on-off valve 43 is open and the on-off valve 48 is close, the pH-adjusted mixture solution is fed into the nitrogen dissolving unit 68 in which nitrogen is dissolved in the pH-adjusted mixture solution. Further, when the on-off valves 56 and 76 are opened, the pH-adjusted nitrogen-dissolved mixture solution is supplied as the rinse solution at the nozzles 6 and 25 to the both major surfaces of the substrate W, and the substrate W is rinsed.

As described above, in this embodiment, since the pH of the rinse solution is adjusted and nitrogen is dissolved in the rinse solution, by means of the effect of lower dissolved oxygen in the rinse solution and the effect of reduced Si elution from the surfaces of a substrate W, it is possible to prevent oxidation of the substrate W and prevent creation of a watermark. In addition, since the mixture solution is stored temporarily within the storage tank 41 and the pH of the rinse solution is then adjusted, it is easy to finely adjust the pH of the rinse solution in this embodiment.

Further, the storage tank 41 is formed by a hermetic tank. Owing to this, as nitrogen is supplied inside the storage tank 41 and the space within the storage tank 41 not filled with the mixture solution is substituted with nitrogen and purged, it is possible to dissolve nitrogen in the mixture solution which is inside the storage tank 41. This consequently attains a similar effect to the effect which is obtained as the nitrogen dissolving unit 68 dissolves nitrogen in the pH-adjusted mixture solution.

In this embodiment as well, a deaeration unit may be disposed on the upstream side to the nitrogen dissolving unit 68 as in the fifth embodiment. For instance, in the event that nitrogen substitution is to be achieved between the nitrogen dissolving unit 68 and the on-off valve 43 or in the storage tank 41, a deaeration unit may be disposed between the storage tank 41 and the on-off valve 202. This structure further reduces the dissolved oxygen concentration in the rinse solution and effectively prevents oxidation of the substrate W, creation of a watermark, etc.

### Seventh Embodiment

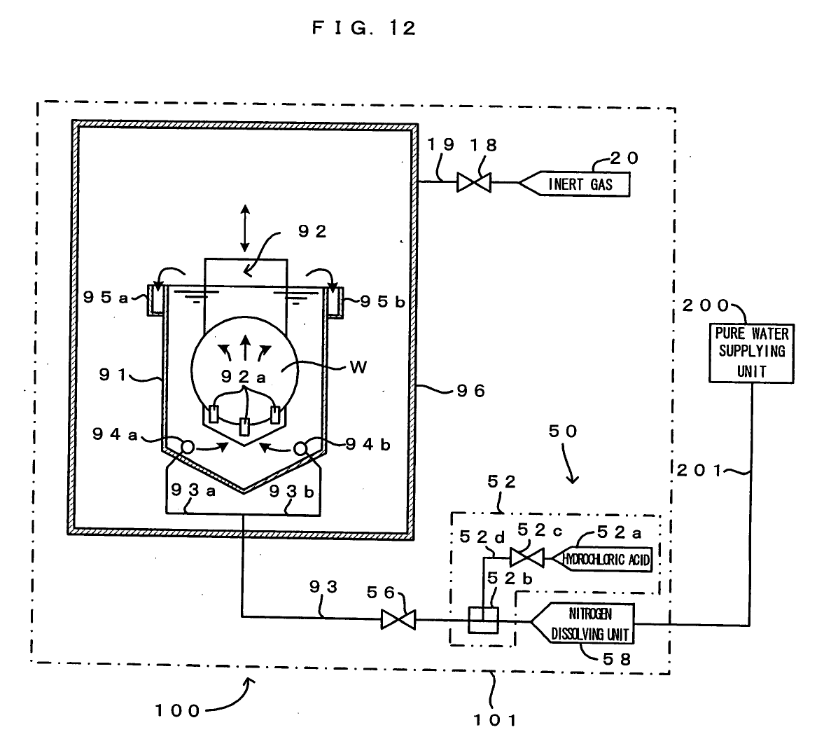

FIG. 12 is a drawing which shows the structure of the substrate processing system according to the seventh embodiment of the present invention. A major difference of the seventh embodiment from the third embodiment is that while hydrochloric acid (diluted hydrochloric acid) is mixed with pure water and the resulting pH-adjusted mixture solution is used as a rinse solution in the third embodiment, nitrogen is dissolved in pure water, hydrochloric acid is then mixed with the nitrogen-dissolved pure water and the resulting pH-adjusted nitrogen-rich fluid is used as a rinse solution in the seventh embodiment. Other structures are basically similar to those according to the third embodiment, and therefore, differences will be mainly described below.

In this embodiment, the pure water supplying unit 200 is connected with an inlet of the nitrogen dissolving unit 58 through the pipe 201, while an outlet of the nitrogen dissolving unit 58 is connected with the rinse solution supplying members 94a and 94b via the pipe 93 in which the on-off valve 56 and the mixing unit 52b are inserted and further via branch pipes 93a and 93b of the pipe 93. In this embodiment, the nitrogen dissolving unit 58 dissolves nitrogen and the pH adjustment unit 52 mixes hydrochloric acid in the pure water which flows toward the nozzle from the pure water supplying unit 200, which is disposed outside the processing main unit 101, along the supply channel (201-93-93a or 201-93-93b) which is connected at one end with the nozzle disposed to the rinse solution supplying members 94a and 94b, thereby adjusting the pH of the mixture solution. The nitrogen-dissolved pH-adjusted mixture solution is then supplied as the rinse solution to each substrate W at the nozzle and rinsing is realized.

As described above, in this embodiment, the rinse solution obtained by mixing hydrochloric acid with nitrogen-dissolved pure water is supplied to multiple substrates W which have been set inside the rinsing bath 91. Since the substrates W are rinsed with the nitrogen-dissolved pH-adjusted rinse solution, the following effects are achieved. That is, the adjusted pH of the rinse solution suppresses elution of Si from the surfaces of the substrates. In addition, nitrogen dissolved in the rinse solution decreases the dissolved oxygen concentration of the rinse solution and further suppresses elution of Si. This prevents oxidation of the substrates W and creation of a watermark.

As described above, in this embodiment, since the rinse solution created by mixing hydrochloric acid in nitrogen-dissolved pure water is supplied to a plurality of substrates W which are immersed in the rinsing bath 91, similar effects to those according to the fifth embodiment are obtained. That is, rinsing of the substrates W with the nitrogen-dissolved pH-adjusted rinse solution achieves the following effects. First, the adjusted pH of the rinse solution suppresses elution of Si from the surfaces of the substrates. In addition, dissolution of nitrogen in the rinse solution reduces the dissolved oxygen concentration in the rinse solution and more effectively suppresses elution of Si. This prevents oxidation of the substrates W, creation of watermarks, etc.

<Other>

The invention is not limited to the embodiments described above but may be modified in various manners in addition to the embodiments above, to the extent not deviating from the object of the invention. For instance, although the embodiments described above require that the both surfaces of a substrate W are treated through the series of processing, the invention may be applied to a substrate processing apparatus and a substrate processing system which treat only one surface. For instance, when it is only one surface of a substrate W that could have a problem of an oxide film, a watermark and the like, execution of the substrate processing on only this surface is more advantageous in terms of cost.

While addition of hydrochloric acid (diluted hydrochloric acid) as the pH adjustor substance realizes adjustment of the pH of the rinse solution in the first through the third embodiments, similar effects are achievable when hydrofluoric acid (diluted hydrofluoric acid) is added. That's because hydrofluoric acid (diluted hydrofluoric acid) is considerably ionizing yet accompanies no problem of residuals. In the event that hydrofluoric acid is to be mixed with pure water for adjustment of the pH of the rinse solution, hydrofluoric acid available from the hydrofluoric acid sources 51 and 71 may be used without disposing the pH adjustment units 52 and 72 in the first embodiment for example described earlier. In this instance, the on-off valves 56 and 76 may be opened while adjusting the on-off valves 53 and 73, to thereby add a predetermined amount of hydrofluoric acid to pure water. This lowers the pH of the rinse solution down to a desired value which is equal to or lower than 5, and prevents rinsing-induced creation of a watermark.

Further, rinsing with the pH-adjusted rinse solution is performed after film removal using hydrofluoric acid but before drying in the first through the third embodiments. In the event that a rinsing step is to be carried out over multiple stages, a substrate W may be rinsed with a rinse solution whose pH has been adjusted to 5 or lower by mixing diluted hydrochloric acid or diluted hydrofluoric acid with pure water during at least the last stage of rinsing which is immediately prior to drying of the substrate W.

In the second embodiment, nitrogen may be supplied inside the air-tight storage tank 41 and the space within the storage tank 41 not filled with the mixture solution may accordingly be substituted with nitrogen and purged, thereby dissolving nitrogen in the mixture solution which is inside the storage tank 41. This achieves a similar effect to the effect which is attained as the nitrogen dissolving units dissolve nitrogen in the pH-adjusted mixture solution.

Further, although hydrochloric acid is added as the “low-pH substance” to adjust the pH of the rinse solution in the embodiments above, this is not limiting. For example, hydrofluoric acid or phosphate may be mixed to obtain similar effects. In the event that hydrofluoric acid is mixed in pure water for adjustment of the pH of the rinse solution, the pH adjustment units 52 and 72 may be omitted and hydrofluoric acid from the hydrofluoric acid sources 51 and 71 which serves as the process solution may be directly used. In this case, the on-off valves 56 and 76 are opened and the on-off valves 53 and 73 are adjusted during rinsing, so that a predetermined amount of hydrofluoric acid is added to the rinse solution. This adjusts the rinse solution to desirable pH. Mixing of hydrofluoric acid after dissolution of nitrogen in pure water for pH adjustment is not limiting, and rather, hydrofluoric acid may be mixed before dissolving nitrogen in pure water for pH adjustment.

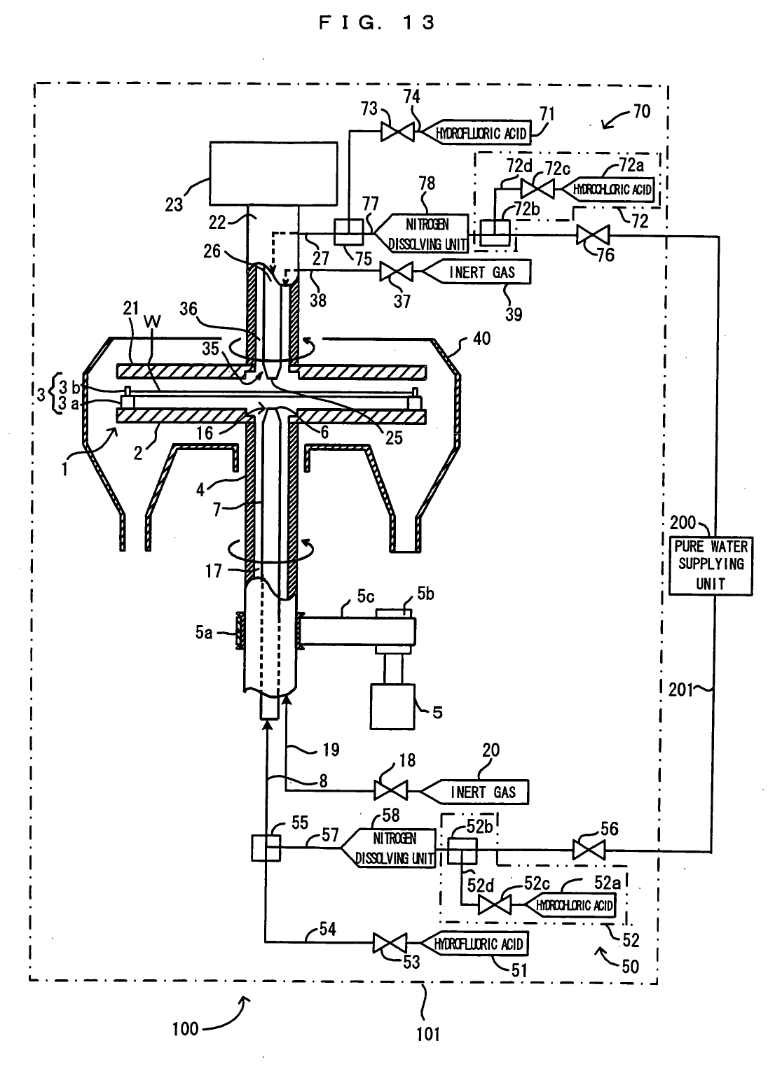

Although the fourth, the fifth and the seventh embodiments require mixing the low-pH substance such as hydrochloric acid in pure water (or deaerated pure water) or nitrogen-rich pure water in which nitrogen has been dissolved to create the rinse solution, the low-pH substance may be mixed with pure water and nitrogen may be then dissolved in this mixture solution, or the low-pH substance and nitrogen may be mixed with pure water at the same time, to create a pH-adjusted nitrogen-rich fluid as the rinse solution. As shown in FIG. 13 for instance, the nitrogen dissolving units 58, 78 may be disposed respectively between the mixing units 55, 75 and the mixing units 52b, 72b, nitrogen may be therefore dissolved in the pH-adjusted mixture solution which flows toward the mixing units 55, 75 and the fluid in which nitrogen has been dissolved may be supplied to a substrate W as the rinse solution at the nozzles 6 and 25.

In this manner, nitrogen is dissolved in the mixture solution which is obtained by mixing diluted hydrochloric acid with pure water on one end side (the side closer to the nozzles 6 and 25) of the supply channel relative to the pH adjustment units 52 and 72, and hence, the following effects are achieved. That is, as nitrogen is dissolved in the mixture solution of pure water and diluted hydrochloric acid, oxygen dissolved in pure water and diluted hydrochloric acid prior to mixing decreases, which more effectively prevents creation of an oxide film, a watermark and the like in a substrate W.

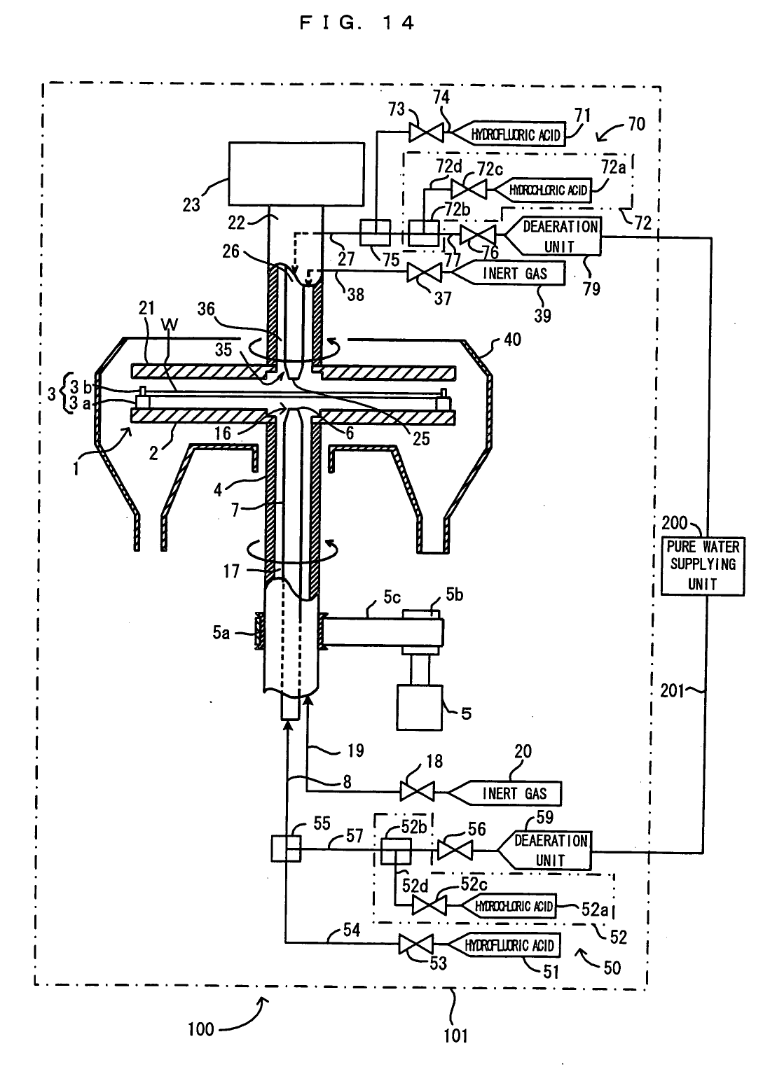

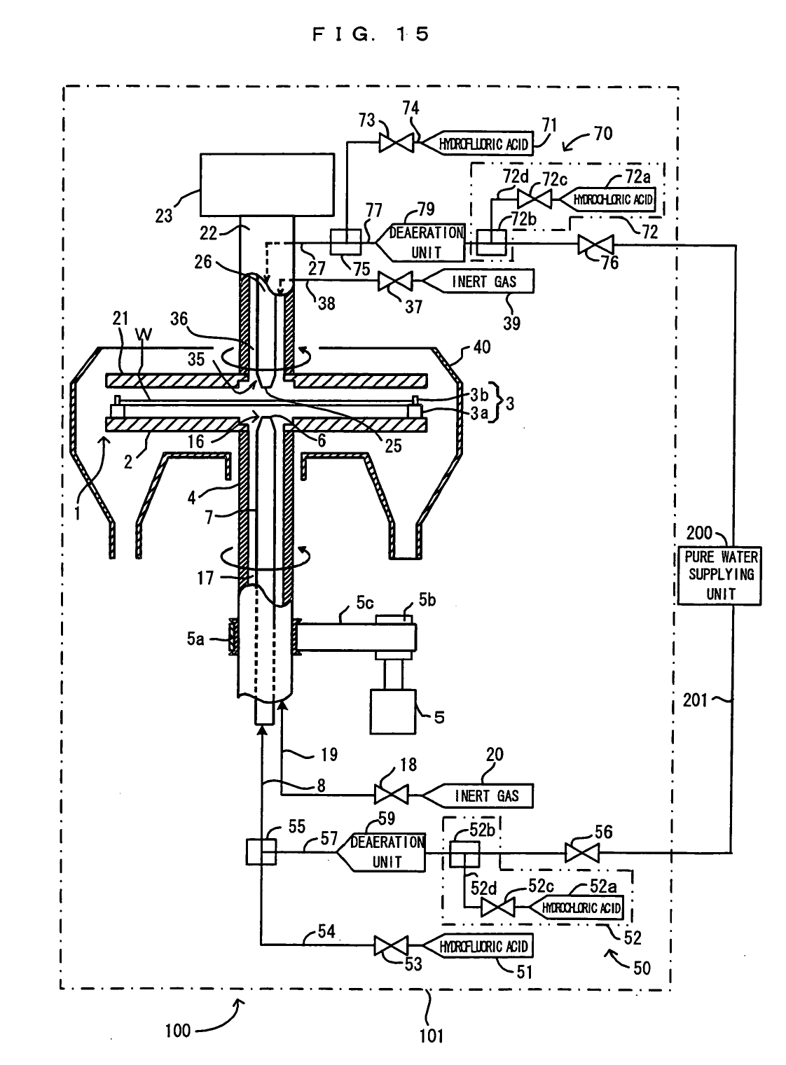

Further, while the foregoing has described that dissolution of nitrogen reduces the dissolved oxygen concentration in the rinse solution in the fourth, the sixth and the seventh embodiments, a deaerator may deaerate pure water or the pH-adjusted mixture solution. In the fourth embodiment for example, the deaeration units (deaerators) 59 and 79 may be disposed instead of the nitrogen dissolving units 58 and 78 as shown in FIG. 14. In this structure, pure water from the pure water supplying unit (pure water supplying unit) 200 is supplied to the substrate processing apparatus (substrate processing unit) 100, and after deaeration, the low-pH substance is mixed in thus deaerated pure water within the processing main unit 101. Alternatively, as shown in FIG. 15, the deaeration units 59 and 79 may be disposed on one end side (the side closer to the nozzles 6 and 25) of the supply channel relative to the pH adjustment units 52 and 72. In this structure, pure water from the pure water supplying unit 200 is supplied to the substrate processing apparatus 100, after the low-pH substance such as hydrochloric acid is mixed in pure water within the processing main unit 101, this mixture fluid is deaerated. Thus pH-adjusted and deaerated fluid is then supplied as the rinse solution to a substrate W at the nozzles 6 and 25 and the substrate W is rinsed. The adjusted pH of the rinse solution and deaeration effectively reduce elution of Si (oxidized substance) from the substrate W and dissolved oxygen, and hence, prevent rinsing-induced creation of an oxide film, a watermark and the like in the substrate W.

In the structure where the mixture solution is deaerated at a mixing location or on one end side (the side closer to the nozzles 6 and 25) of the supply channel relative to the pH adjustment units 52 and 72 (FIG. 15) in particular, since the mixture solution of pure water and the low-pH substance is deaerated. Hence, oxygen dissolved in pure water and the low-pH substance before mixing decreases and the effects above are more preferably attained.

In addition, a nitrogen dissolving unit may be disposed on the downstream side (nozzle side) to the deaerator, to thereby dissolve nitrogen (corresponds to the “nitrogen dissolving step” of the present invention) in the deaerated pure water or deaerated pH-adjusted mixture solution (hereinafter referred to as “deaerated fluid(s)”). This prevents oxygen from getting dissolved in the deaerated fluid as time passes since deaeration, and further reduces the dissolved oxygen concentration in the deaerated fluid.

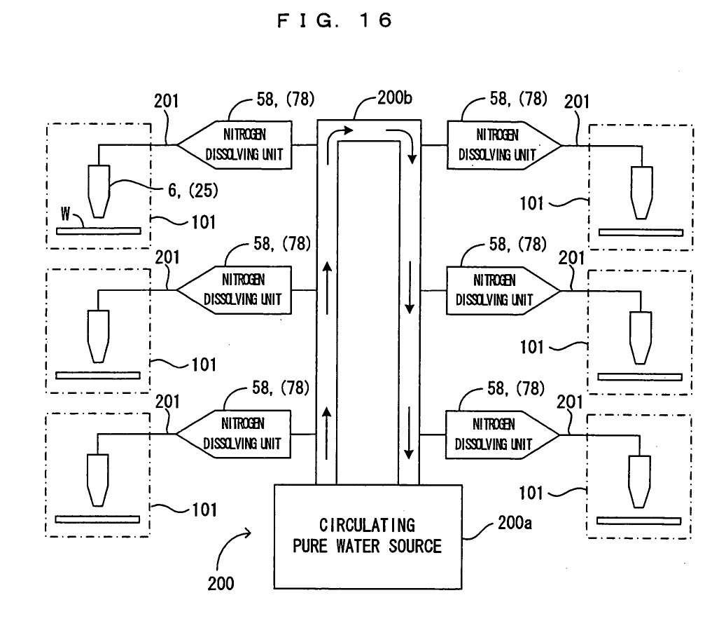

Further, while the nitrogen dissolving unit 58 (78) is disposed inside the processing main unit 101 in the fourth to the seventh embodiments, as shown in FIG. 16, the nitrogen dissolving unit 58 (78) may be disposed outside the processing main unit 101. To be more specific, the nitrogen dissolving unit 58 (78) may be inserted in the plant water line (pipe 201) of the factory which links the pure water supplying unit (pure water supplying unit) 200 with the processing main unit 101. When the nitrogen dissolving unit 58 (78) is disposed outside the processing main unit 101 in this manner, the processing main unit 101 is advantageously compact.

Describing the pure water supplying unit 200 in detail with reference to FIG. 16, the pure water supplying unit 200 comprises a pure water source 200a from which pure water is supplied and a circulation channel 200b in which pure water from the pure water source 200a returns back to the pure water source 200a and thus circulates. Pure water circulating in the circulation channel 200b is deaerated in a deaeration facility (not shown), and the dissolved oxygen concentration in this pure water is accordingly reduced. However, even despite preliminary reduction of the dissolved oxygen concentration through deaeration, before the pure water reaches the processing main unit 101 via the plant water line (pipe 201) which branches off from the circulation channel 200b and links to the processing main unit 101, oxygen gets dissolved in the pure water and the dissolved oxygen concentration in this pure water starts rising immediately after deaeration.

In contrast, in the event that the nitrogen dissolving unit 58 (78) is disposed outside the processing main unit 101 so that the nitrogen dissolving unit 58 (78) dissolves nitrogen in pure water, it is possible to suppress an increase of the dissolved oxygen concentration in pure water which reaches the processing main unit 101. It is desirable in light of this that the nitrogen dissolving unit 58 (78) is located right behind the branching from the circulation channel 200b where oxygen could get dissolved in pure water. See from considering the duration of the effect of added nitrogen, it is equally desirable that the nitrogen dissolving unit 58 (78) is located such that the volume of the rinse solution inside the distribution channel before arriving at the end of the nozzle 6 (25) remains 200 liter or more.

In the event that the nitrogen dissolving unit 58 (78) is disposed outside the processing main unit 101 in the fifth embodiment above, it is desirable to dispose the deaeration unit 59 (79) on the upstream side to the nitrogen dissolving unit 58 (78) and outside the processing main unit 101. This is because as the elapsed time since deaeration until dissolution of nitrogen is shortened, the dissolved oxygen concentration in the rinse solution is effectively reduced.

Further, the pH adjustment units 52 and 72 or the cabinet 400 as well may be disposed outside the processing main unit 101. This arrangement makes the processing main unit 101 compact.

Still further, the foregoing has described that a substrate W is wet-processed while supplying a hydrofluoric acid solution to the substrate W as the process solution in the embodiments above, the invention may be applied to a substrate processing apparatus and a substrate processing system which execute predetermined wet processing (such as cleaning and development) while supplying other process solution than this to a substrate. In brief, the invention is generally applicable to any substrate processing apparatus and any substrate processing system which perform rinsing while supplying a rinse solution to a substrate.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

1. A substrate processing method, comprising:
a wet processing step of supplying a processing liquid to a substrate, thereby performing predetermined wet processing;
a rinse solution creating step of creating a rinse solution; and
a rinsing step of feeding the rinse solution to a nozzle along a supply channel which is connected at one end with the nozzle after the wet processing step, thereby supplying the rinse solution at the nozzle to the substrate and rinsing the substrate with the rinse solution,
wherein the rinse solution creating step is a step at which diluted hydrochloric acid or diluted hydrofluoric acid is mixed with the pure water which is fed from the other end side of the supply channel so that the pH of the rinse solution is of 5 or lower is created.

2. The substrate processing method of claim 1, further comprising a drying step of drying the substrate which is rinsed at the rinsing step,
wherein the rinse step is executed immediately before the drying step.

3. The substrate processing method of claim 1, further comprising a nitrogen dissolving step of dissolving nitrogen in a fluid which flows in the supply channel.

4. A substrate processing apparatus, comprising:
a nozzle; and
a pH adjustor which mixes diluted hydrochloric acid or diluted hydrofluoric acid with pure water which flows toward the nozzle along a supply channel which is connected at one end with the nozzle, thereby adjusting the pH of a mixture solution which flows in the supply channel to 5 or lower,
wherein the mixture solution whose pH has been adjusted by the pH adjustor is fed as a rinse solution toward the nozzle along the supply channel and supplied at the nozzle to a substrate, and the substrate is rinsed with the rinse solution.

5. The substrate processing apparatus of claim 4, further comprising a nitrogen dissolver which dissolves nitrogen in the fluid which flows in the supply channel.

6. A substrate processing method, comprising:
a wet processing step of supplying a processing liquid to a substrate, thereby performing predetermined wet processing;
a rinse solution creating step of creating a rinse solution; and
a rinsing step of feeding the rinse solution to a nozzle along a supply channel which is connected at one end with the nozzle after the wet processing step, thereby supplying the rinse solution at the nozzle to the substrate, and rinsing the substrate with the rinse solution,
wherein the rinse solution creating step is a step at which a low-pH substance whose pH is lower than that of pure water is mixed at a predetermined mixing location on the supply channel with the pure water which is fed in from the other end side of the supply channel, nitrogen is dissolved in a fluid which flows in the supply channel and the rinse solution is created.

7. The substrate processing method of claim 6, wherein at the rinse solution creating step, the low-pH substance is mixed at the predetermined mixing location with the pure water, thereby creating a mixture solution whose pH is 2 to 6, and nitrogen is dissolved in the mixture solution which flows in the supply channel on one end side of the supply channel relative to the predetermined mixing location, thereby creating the rinse solution.

8. The substrate processing method of claim 6, further comprising a deaeration step of deaerating the fluid which flows in the supply channel on the other end side of the supply channel relative to the nitrogen dissolution location on the supply channel at which nitrogen is dissolved.

9. The substrate processing method of claim 6, wherein the rinsing step is carried out in an inert gas atmosphere.

10. A substrate processing method, comprising:
a wet processing step of supplying a processing liquid to a substrate, thereby performing predetermined wet processing;
a rinse solution creating step of creating a rinse solution; and
a rinsing step of feeding the rinse solution to a nozzle along a supply channel which is connected at one end with the nozzle after the wet processing step, thereby supplying the rinse solution at the nozzle to the substrate, and rinsing the substrate with the rinse solution,
wherein the rinse solution creating step is a step at which a low-pH substance whose pH is lower than that of the pure water is mixed at a predetermined mixing location on the supply channel with the pure water which is fed in from the other end side of the supply channel, a fluid which flows in the supply channel is deaerated and the rinse solution is created.

11. The substrate processing method of claim 10, wherein at the rinse solution creating step, the low-pH substance is mixed at the predetermined mixing location with the pure water, thereby creating a mixture solution whose pH is 2 to 6, and the mixture solution which flows in the supply channel is deaerated on one end side of the supply channel relative to the predetermined mixing location, thereby creating the rinse solution.

12. The substrate processing method of claim 10, further comprising a nitrogen dissolving step of dissolving nitrogen in the fluid which flows in the supply channel on the other end side of the supply channel relative to the deaeration location in the supply channel at which deaeration is performed.

13. The substrate processing method of claim 10, wherein the rinsing step is carried out in an inert gas atmosphere.

14. A substrate processing apparatus, comprising:
a nozzle;
a pH adjustor which mixes a low-pH substance whose pH is lower than that of pure water with the pure water which flows toward the nozzle along a supply channel which is connected at one end with the nozzle, thereby adjusting the pH of a fluid which flows in the supply channel; and
a nitrogen dissolver which dissolves nitrogen in the fluid which flows in the supply channel,
wherein the fluid whose pH has been adjusted by the pH adjustor and in which nitrogen has been dissolved by the nitrogen dissolver is fed as a rinse solution toward the nozzle along the supply channel and supplied at the nozzle to the substrate, and the substrate is rinsed with the rinse solution.

15. The substrate processing apparatus of claim 14, wherein the nitrogen dissolver is disposed on one end side of the supply channel relative to the pH adjustor.

16. The substrate processing apparatus of claim 14, further comprising a deaerator which is disposed on the other end side of the supply channel relative to the nitrogen dissolver and deaerates the fluid which flows in the supply channel.

17. The substrate processing apparatus of claim 14, further comprising:
an atmosphere blocker which is disposed facing but away from the substrate to which the rinse solution is supplied; and
an inert gas supplier which supplies inert gas to the space which is created between the atmosphere blocker and the substrate.

18. A substrate processing apparatus, comprising:
a nozzle;
a pH adjustor which mixes a low-pH substance whose pH is lower than that of pure water with the pure water which flows toward the nozzle along a supply channel which is connected at one end with the nozzle, thereby adjusting the pH of a fluid which flows in the supply channel; and
a deaerator which deaerates the fluid which flows in the supply channel,
wherein the fluid whose pH has been adjusted by the pH adjustor and which has been deaerated by the deaerator is fed as a rinse solution toward the nozzle along the supply channel and supplied at the nozzle to the substrate, and the substrate is rinsed with the rinse solution.

19. The substrate processing apparatus of claim 18, wherein the deaerator is disposed on one end side of the supply channel relative to the pH adjustor.

20. The substrate processing apparatus of claim 18, further comprising a nitrogen dissolver which is disposed on one end side of the supply channel relative to the nitrogen dissolver and dissolves nitrogen in the fluid which flows in the supply channel.

21. The substrate processing apparatus of claim 18, further comprising:
an atmosphere blocker which is disposed facing but away from the substrate to which the rinse solution is supplied; and
an inert gas supplier which supplies inert gas to the space which is created between the atmosphere blocker and the substrate.

22. A substrate processing system comprising:
a pure water supplying unit which supplies pure water; and
a substrate processing unit which rinses a substrate with a rinse solution including the pure water supplied from the pure water supplying unit,
wherein the substrate processing unit internally comprises: a nozzle; a pH adjustor which mixes a low-pH substance whose pH is lower than that of the pure water with the pure water which flows toward the nozzle along a supply channel which is connected at one end with the nozzle, thereby adjusting the pH of a fluid which flows in the supply channel; and a nitrogen dissolver which dissolves nitrogen in the fluid which flows in the supply channel, and
wherein the fluid whose pH has been adjusted by the pH adjustor and in which nitrogen has been dissolved by the nitrogen dissolver is fed as the rinse solution toward the nozzle along the supply channel and supplied at the nozzle to the substrate, and the substrate is rinsed with the rinse solution.

23. A substrate processing system comprising:
a pure water supplying unit which supplies pure water;
a substrate processing unit which rinses a substrate with a rinse solution including the pure water supplied from the pure water supplying unit; and
a nitrogen dissolver which dissolves nitrogen in the pure water supplied from the pure water supplying unit,
wherein the substrate processing unit internally comprises:
a nozzle; and
a pH adjustor which mixes a low-pH substance whose pH is lower than that of the pure water with the pure water which flows toward the nozzle along a supply channel connected at one end with the nozzle and in which nitrogen has been dissolved by the nitrogen dissolver, thereby adjusting the pH of a fluid which flows in the supply channel, and
wherein the fluid in which nitrogen has been dissolved by the nitrogen dissolver and whose pH has been adjusted by the pH adjustor is fed as the rinse solution toward the nozzle along the supply channel and supplied at the nozzle to the substrate, and the substrate is rinsed with the rinse solution.

24. A substrate processing system comprising:
a pure water supplying unit which supplies pure water; and
a substrate processing unit which rinses a substrate with a rinse solution including the pure water supplied from the pure water supplying unit,
wherein the substrate processing unit internally comprises:
a nozzle;
a pH adjustor which mixes a low-pH substance whose pH is lower than that of the pure water with the pure water which flows toward the nozzle along a supply channel which is connected at one end with the nozzle, thereby adjusting the pH of a fluid which flows in the supply channel; and
a deaerator which deaerates the fluid which flows in the supply channel, and
wherein the fluid whose pH has been adjusted by the pH adjustor and which has been deaerated by the deaerator is fed as a rinse solution toward the nozzle along the supply channel and supplied at the nozzle to the substrate, and the substrate is rinsed with the rinse solution.
